(19) United States
(12) Patent Application Publication
(10) Pub. No.: US 2019/0392441 A1
(43) Pub. Date: Dec. 26, 2019

(54) CUSTOMIZING AUTHORIZATION REQUEST SCHEDULES WITH MACHINE LEARNING MODELS

(71) Applicant: Apple Inc., Cupertino, CA (US)

(72) Inventors: Bilung Lee, San Jose, CA (US); Harish Vijendran, Sunnyvale, CA (US); Michael K. Chu, Cupertino, CA (US); Mingzhu Zhu, San Jose, CA (US); Payam Mirrashidi, Los Altos, CA (US); Wayne A. Yap, San Francisco, CA (US); Eric J. Gray, Sunnyvale, CA (US); Chunlai Ma, Dublin, CA (US)

(21) Appl. No.: 16/451,795

(22) Filed: Jun. 25, 2019

Related U.S. Application Data
(60) Provisional application No. 62/689,654, filed on Jun. 25, 2018.

(51) Int. Cl. G06Q 20/40; G06N 20/00

(52) U.S. Cl. CPC G06Q 20/40; G06N 20/00

(57) ABSTRACT

Systems, methods, and computer-readable media are provided for customizing an authorization request schedule. In some embodiments, application of one or more statistical or rule-based models may be combined with the use of one or more learning-based models to provide a hybrid model approach to customizing an authorization request schedule that may allow for the personalization and flexibility of a learning model as well as the fine tunability of a statistical model.

### CROSS-REFERENCE TO RELATED APPLICATION(S)

This application claims the benefit of prior filed U.S. Provisional Patent Application No. 62/689,654, filed Jun. 25, 2018, which is hereby incorporated by reference herein in its entirety.

### TECHNICAL FIELD

This disclosure relates to customizing authorization request schedules and, more particularly, to customizing with machine learning models the number and timing of authorization requests of an authorization request schedule for use in obtaining authorization from a credential manager subsystem of a transaction between a service provider subsystem and a customer.

### BACKGROUND OF THE DISCLOSURE

A payment for funding a service transaction between a customer and a service provider (e.g., for any suitable goods/services of an online media store) using a transaction credential managed by a credential manager (e.g., a payment instrument of a financial institution) may be scheduled for authorization at a particular scheduled authorization time, and the service provider may send an authorization request for the service transaction to the credential manager at that particular scheduled authorization time. However, oftentimes, such an authorization request may fail (e.g., due to downtime of the credential manager or expiration of the transaction credential) and one or more additional authorization requests may then be made.

### SUMMARY OF THE DISCLOSURE

This document describes systems, methods, and computer-readable media for customizing authorization request schedules.

As an example, a method for customizing, using a management server, an authorization request schedule afforded to a customer in a transaction for a product between a service provider and the customer using a payment credential is provided that may include detecting, with the management server, a transaction due date for a payment in the transaction using the payment credential, identifying, with the management server, a plurality of potential request times associated with the detected transaction due date, for each potential request time of the identified plurality of potential request times, running, with the management server, a trained authorization request approval probability model on transaction feature data associated with the transaction to predict a probability of an authorization request approval of the payment for that potential request time, selecting, with the management server, a particular potential request time of the identified plurality of potential request times, calculating, with the management server, an expected gain for the selected particular potential request time using the predicted probability of an authorization request approval of the payment for the selected particular potential request time, comparing, with the management server, the calculated expected gain for the selected particular potential request time to a comparator, and determining, with the management server, whether or not to add the selected particular potential request time to the authorization request schedule based on the comparing.

As another example, a system for customizing an authorization request schedule is provided that may include a credential manager subsystem that manages a payment credential of a customer, and a service provider subsystem that offers a product to the customer, wherein the service provider subsystem may be configured to detect a due date for a payment using the payment credential in a transaction for the product between the service provider subsystem and the customer, in response to the detection of the due date, identify a plurality of potential request times associated with the due date, for each potential request time of the identified plurality of potential request times: predict, using a trained probability model, a probability of an authorization request approval of the payment if made at that potential request time, calculate an expected gain for the that potential request time using the predicted probability of an authorization request approval of the payment if made at that potential request time, and selectively update the authorization request schedule with that potential request time based on the calculated expected gain for that potential request time, and, at a first potential request time of the updated authorization request schedule, request, of the credential manager subsystem, an authorization of the payment using the payment credential.

As yet another example, a non-transitory machine readable medium storing a program for execution by at least one processing unit of a management server is provided, the program for customizing an authorization request schedule, the program including sets of instructions for predicting, using a trained probability model, a probability of an authorization request approval of a payment if made at a potential request time, calculating, using a statistical model, an expected gain for the potential request time based on the predicted probability, adding the potential request time to the authorization request schedule based on the calculated expected gain, and, after the adding, at the potential request time of the authorization request schedule, attempting to obtain approval of an authorization request of the payment.

This Summary is provided only to present some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters refer to like parts throughout, and in which:

FIG. 1 is a schematic view of an illustrative system for customizing authorization request schedules;

FIG. 2 is a more detailed schematic view of an example electronic device of the system of FIG. 1;

FIG. 3 is a front view of the example electronic device of FIGS. 1 and 2;

FIG. 4 is a more detailed schematic view of an example service provider subsystem of the system of FIG. 1;

FIG. 5 is a more detailed schematic view of an illustrative portion of the example service provider subsystem of FIGS. 1 and 4; and

FIG. 6 is a flowchart of an illustrative process for customizing authorization request schedules.

### DETAILED DESCRIPTION OF THE DISCLOSURE

Systems, methods, and computer-readable media may be provided for customizing authorization request schedules. A payment for funding a service transaction between a customer and a service provider (e.g., for any suitable goods/services of an online media store) using a transaction credential managed by a credential manager (e.g., a payment instrument of a financial institution) may be initially scheduled for authorization at a particular scheduled authorization time (e.g., 30 days or 365 days after an initiation event, such as an initial subscription to a monthly or annual subscription service or any suitable installment plan or upgrade schedule or the like that may result in a payment schedule). However, an authorization request schedule may be defined in an optimized manner to guide when the service provider might attempt to request authorization from the credential manager for funding the service transaction in a customized manner based on actual features of the customer and/or the transaction and/or the credential manager and/or the like. A goal may be to customize the number of scheduled authorization requests and/or the scheduled time of each scheduled authorization request of a customized authorization request schedule afforded by the service provider to a particular customer for a particular transaction using a particular transaction credential, such that the customized schedules for all transactions may be operative to maximize the number of successful authorization requests attempted by the system for all transactions (e.g., to increase efficiency) and/or to minimize the total number of authorization requests attempted by the system for all transactions (e.g., to reduce transaction fees and/or operation traffic costs that may be associated with requesting transaction authorization). An authorization request approval probability may be identified using one or more authorization request approval probability models and a particular set of model input features based on particular transaction data associated with a particular customer and a particular transaction and a particular transaction credential, such that the scheduling of an authorization request schedule for that particular transaction may be personalized to the particular customer and/or different types of authorization request schedules may be afforded to different customers and/or different authorization request schedules may be afforded to a particular customer over time based on that particular customer's behavior. In some embodiments, certain characteristics of a scheduled authorization request schedule may be dynamically changed during the pendency of that authorization request schedule based on new real-time data that may be made available to the system. Use of one or more machine learning models may enable a data driven model for customizing an authorization request schedule as opposed to a pre-defined authorization request schedule, a dynamically refreshable active authorization request schedule as opposed to a static authorization request schedule, and/or a probability based authorization request schedule as opposed to only a rule based authorization request schedule. In some embodiments, application of one or more statistical or rule-based models may be combined with the use of one or more learning-based models to provide a hybrid model approach that may allow for the personalization and flexibility of a learning model as well as the fine tunability of a statistical model.

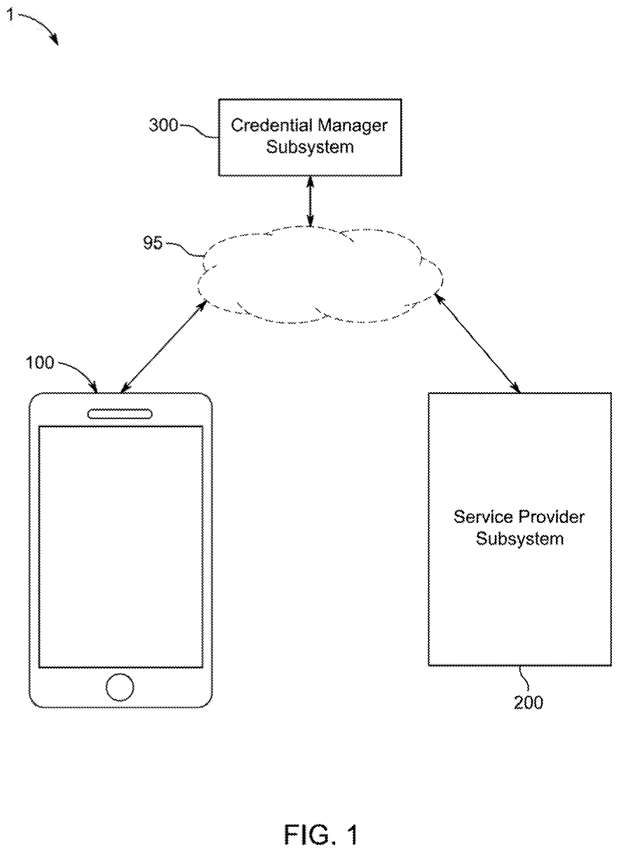

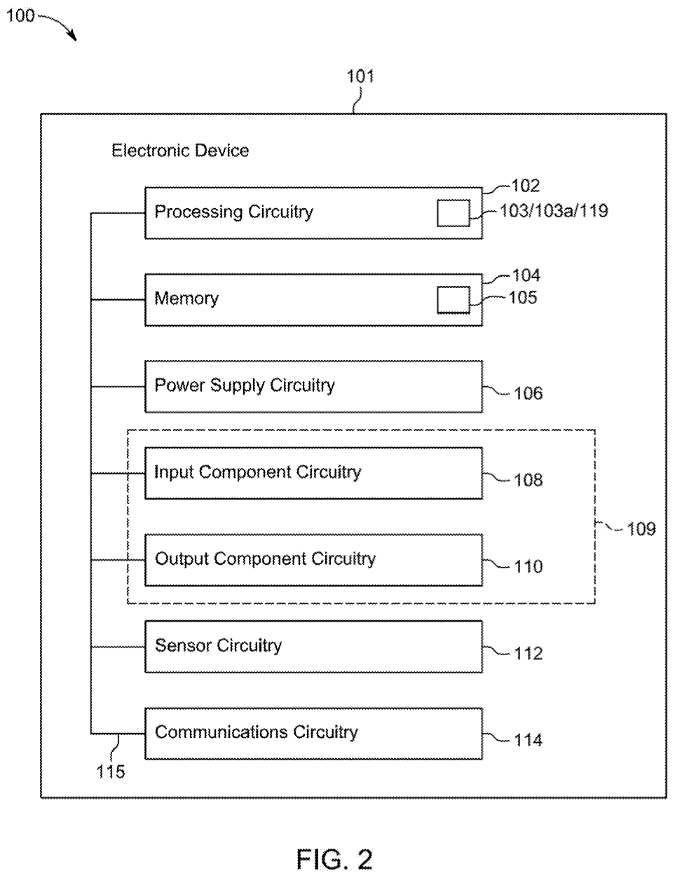

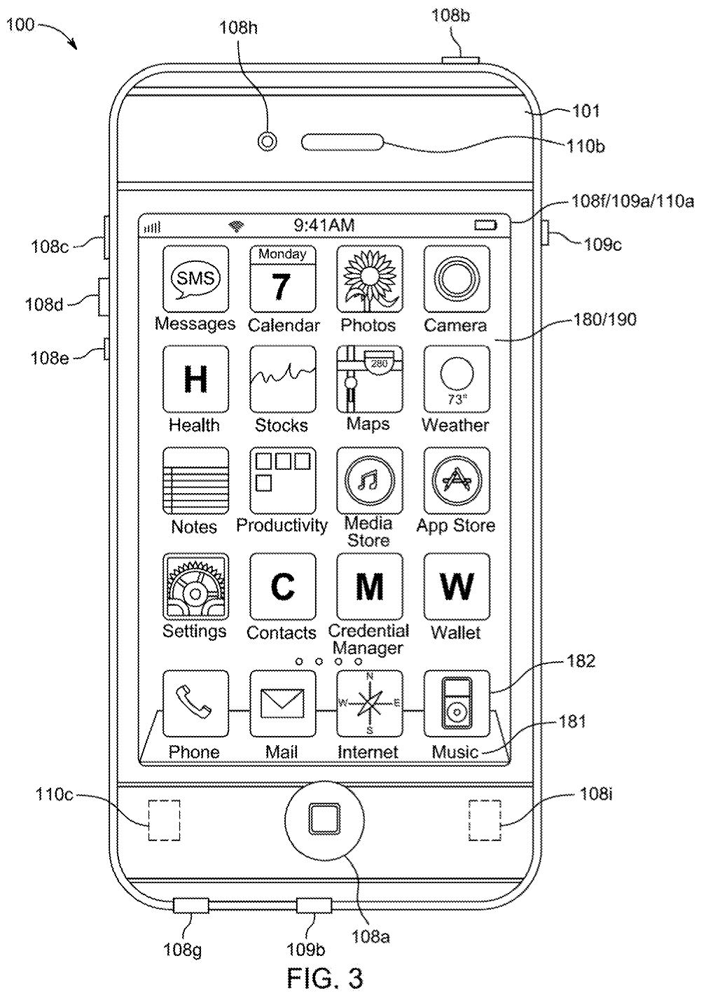

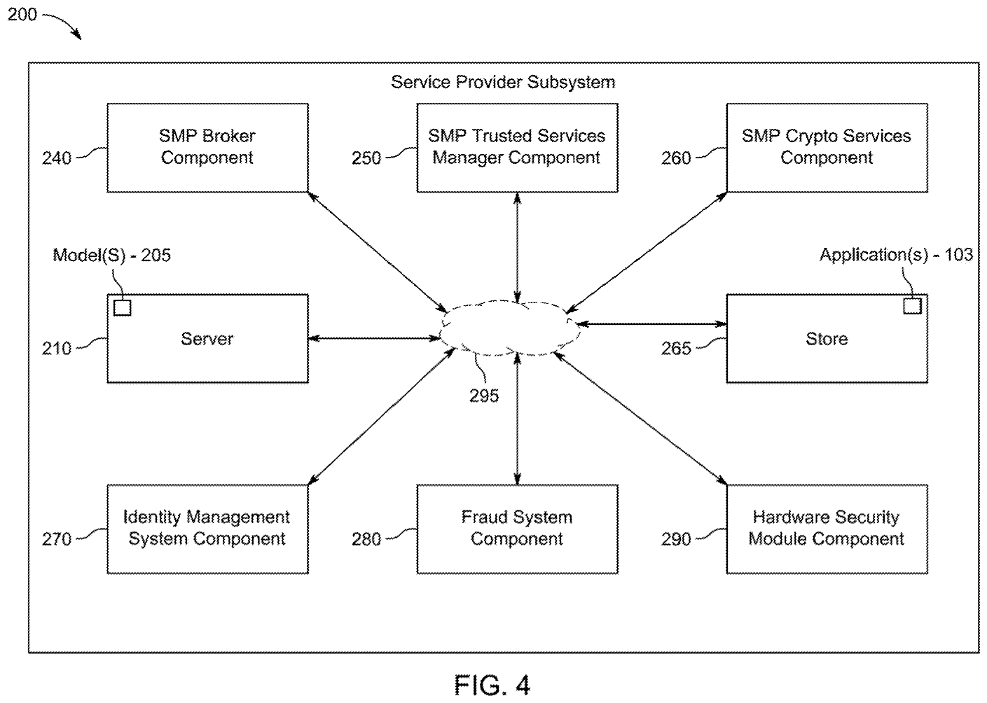

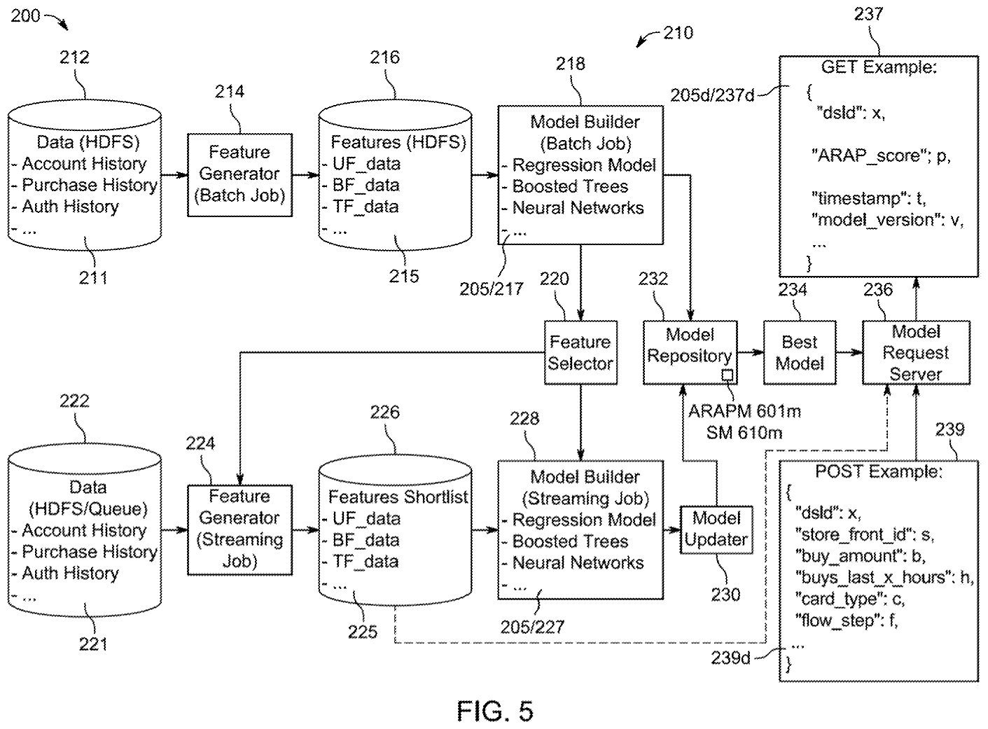

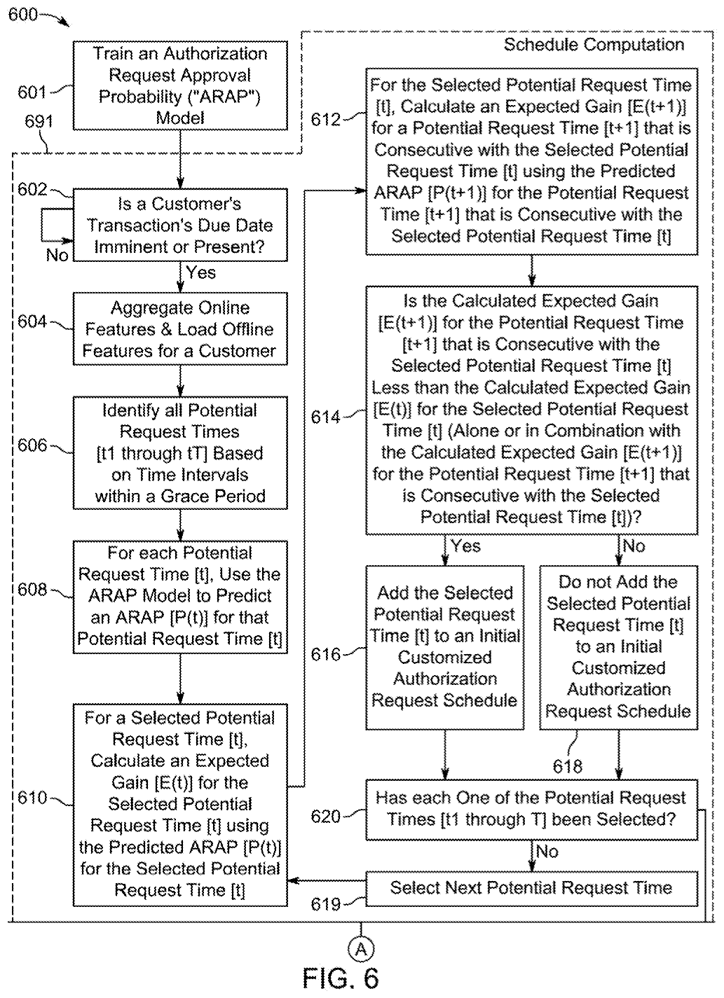

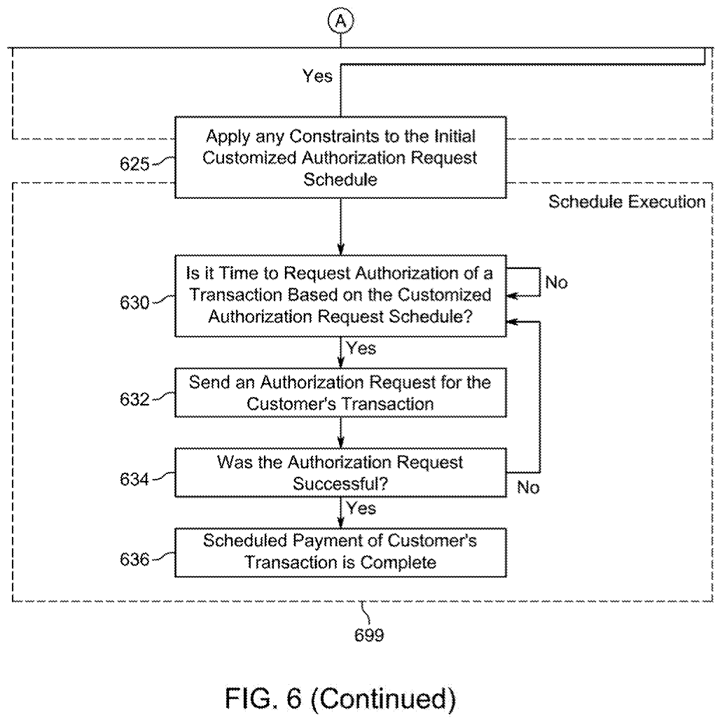

FIG. 1 shows a system 1 in which an authorization request schedule may be customized for defining when an authorization request ought to be made for funding a transaction between a service provider (“SP”) subsystem 200 and a user of a user electronic device 100 using a transaction credential managed by a credential manager (“CM”) subsystem 300, while FIGS. 2 and 3 show further details with respect to particular embodiments of electronic device 100 of system 1, FIGS. 4 and 5 show further details with respect to particular embodiments of SP subsystem 200 of system 1, and FIG. 6 is a flowchart of an illustrative process for customizing authorization request schedules.

### Description of FIG. 1

FIG. 1 is a schematic view of an illustrative system 1 that may allow for customization of an authorization request schedule for defining when an authorization request ought to be made for funding a transaction between SP subsystem 200 and a user of user electronic device 100 using a transaction credential managed by CM subsystem 300. Once an authorization request schedule has been customized for attempting to fund a particular service transaction (e.g., for one or more goods or services of the SP (e.g., SP product)) using a customer transaction credential (e.g., credit card credential, debit card credential, loyalty card credential, stored value credential, etc.) that may be managed by CM subsystem 300 (e.g., a financial institution subsystem), SP subsystem 200 may communicate to CM subsystem 300 a transaction authorization request with any suitable SP authorization request data that may be indicative of the service transaction according to the customized authorization request schedule. Such SP authorization request data may include data indicative of the customer transaction credential as well as data indicative of the total amount of funds required from a funding account associated with the customer transaction credential (e.g., an account managed by CM subsystem 300 on behalf of the customer) in order to fund the service transaction as well as any suitable additional transaction information indicative of the transaction, such as a limited transaction descriptor that may be indicative of the identity of SP subsystem 200, and/or of the goods or services purchased, and/or the like. CM subsystem 300 may use such SP authorization request data to determine whether or not to approve or decline the transfer of funds from the funding account associated with the customer transaction credential to an account associated with SP subsystem 200 (e.g., to fund the service transaction on behalf of the customer).

A transaction authorization request may be declined by CM subsystem 300 or otherwise unsuccessful for any suitable reason, such as CM subsystem 300 being temporarily offline, the customer transaction credential being temporarily suspended, the customer transaction credential being invalid (e.g., due to the expiration date of the credential having been passed), and/or the like. Moreover, each transaction authorization request made by SP subsystem 200 may have any suitable cost associated therewith, including, but not limited to, an operational cost, a transactional cost, and/or the like, to which a particular monetary value may be calculated or used to represent the cost to SP subsystem 200 of a transaction authorization request. Therefore, a goal may be to customize any suitable aspects of an authorization request schedule (e.g., the number and/or the timing of authorization requests of an authorization request schedule) afforded by the SP subsystem to a customer for minimizing the number of authorization requests and/or for maximizing the number of successful authorization requests and/or otherwise improving or optimizing or maximizing the success rate of each authorization request of the schedule (e.g., for reducing costs associated with carrying out an authorization request).

Various types of data may be used to determine the probability of success of an authorization request to be made at each one of various particular times for a particular transaction. At least one suitable authorization request approval probability (“ARAP”) model, such as any suitable machine learning model (e.g., a binary classification model, a multi-class classification model, a regression model, a random forest model, a gradient boosted tree model, an ensemble model, a neural network (e.g., a deep or wide or deep and wide neural network), a learning engine, models that are non-machine learning models or non-statistical learning based models, where such engines may include policy- or operations-based rules, third party learning application programming interfaces (“APIs”), etc., and/or the like), may be trained and utilized in conjunction with any suitable transaction data for customizing an authorization request schedule to be utilized by SP subsystem 200. For example, as described with respect to FIGS. 4-6, any suitable ARAP model may be trained in conjunction with any suitable number of sets of any suitable transaction data that may be indicative of any suitable features or categories or characteristics of one or more previous authorization requests made for transactions by any customers (e.g., a successful or unsuccessful authorization request), and the eventual success or failure of the funding of the authorization request transaction of the set may be used as the truth (e.g., ground truth) for the training set, where such transaction data for a particular authorization request for a particular transaction may be indicative of any suitable characteristics, features (e.g., model input features), or categories of the authorization request, including, but not limited to, time features (“TF”), billing features (“BF”), and user features (“UF”). Such time features for a particular authorization request for a particular transaction may include any suitable features, including, but not limited to, time of day and/or day of week and/or day of month and/or month of year of the transaction due date associated with the transaction (e.g., the moment that a monthly subscription service is due to be up for renewal), time of day and/or day of week and/or day of month and/or month of year of the authorization request associated with the transaction, amount of time between the authorization request for the transaction and a previous authorization request for the transaction (if any), and/or amount of time between the transaction due date and the authorization request. Such billing features for a particular authorization request for a particular transaction may include any suitable features, including, but not limited to, amount of time that the customer transaction credential of the transaction has been known by the SP subsystem, the type of customer transaction credential (e.g., store credit, credit card, debit card), the CM subsystem responsible for the customer transaction credential, the expiration date of the customer transaction credential, number of times a customer has updated at the SP subsystem the billing information associated with the transaction, the amount of time since the last time the customer updated at the SP subsystem the billing information associated with the transaction, the type of billing error associated with the authorization request if it was unsuccessful (e.g., credential declined, credential delinquent, network problem (e.g., CM subsystem was offline), etc.), number and/or time(s) of any previously attempted and failed authorization requests made for the transaction, amount spent on various products (e.g., subscription, songs, books, etc.) for the customer transaction credential, duration since last authorization failure/success for the customer transaction credential, ratio of free versus paid purchases for the customer transaction credential, number of first authorization attempt failure/success for the customer transaction credential, maximum number of authorization attempts on a transaction for the customer transaction credential, and/or the like. Such user features for a particular authorization request for a particular transaction may include any suitable features, including, but not limited to, family status of customer (e.g., family member, shared family plan, individual customer, etc.), length of customer association with the SP product associated with the transaction (e.g., days the customer has been subscribed to or using a service that is up for renewal through the transaction), information indicative of any suitable customer engagement with the SP product associated with the transaction (e.g., number of songs played by the customer using a subscription music streaming service that is up for renewal through the transaction, etc.), location of the customer, amount spent on various products (e.g., subscription, songs, books, etc.) for the customer, duration since last authorization failure/success for the customer, ratio of free versus paid purchases for the customer, number of first authorization attempt failure/success for the customer, maximum number of authorization attempts on a transaction for the customer, and/or the like. Then, such an ARAP model may be used (e.g., at operation 608 of process 600 of FIG. 6) to predict or otherwise determine a probability of success of an authorization request to be made at each one of various particular potential request times in the future for a particular transaction for a particular customer for a particular SP product using a particular credential. The particular potential request times may be differentiated by any suitable time interval across any suitable grace period (e.g., starting at or slightly before or slightly after the transaction due date) within which the authorization requests may be scheduled (e.g., a grace period of 10 days starting from the transaction due date, at a time interval of 1 hour, such that there may be 240 potential request times)). Such an ARAP model may be trained via any suitable supervised approach (e.g., logistic regression, random forest, gradient boosted decision trees, deep learning (e.g., long short term memory (“LSTM”))) and developed (e.g., at operation 601 of process 600 of FIG. 6) for use in determining (e.g., at operation 608 of process 600 of FIG. 6) a particular probability (e.g., a discrete class or continuous numerical value) for each potential request time that ought to be considered for at least partially determining a customized authorization request schedule. Therefore, an authorization request approval probability may be identified for each potential request time using one or more ARAP models based on particular transaction data associated with a particular customer and a particular transaction purchase attempt, such that different authorization request schedules may be personalized to a particular customer over time based on that particular customer's behavior. An ARAP model may be trained to output an authorization request approval probability (“ARAP”) score P for each one of any suitable future potential request time t (e.g., a value between 0 (e.g., indicative of a 0% chance of success of the authorization request if made at the particular potential request time) and 1 (e.g., indicative of a 100% chance of success of the authorization request if made at the particular potential request time)) for a particular customer's transaction using any suitable model input features of that transaction. Therefore, such an ARAP model (e.g., ARAPM 601m of FIG. 5) may be trained to provide a model function ƒ(TF, BF, UF)=P(t). Such an ARAP model may be trained to model function ƒ using any suitable supervised approach, including, but not limited to, logistic regression, random forest, gradient boosted decision trees, deep learning (e.g., LSTM), and/or the like. However, in order to train such a model using historical transaction data as model input features, accurate model outputs or model labels should first be determined for use in such training (e.g., by identifying the result of the historical transactions used to train the model).

In some embodiments, certain characteristics of an authorization request schedule may be dynamically changed during the pendency of that authorization request schedule based on new real-time data that may be made available to the system. For example, an authorization request schedule may be provided with a dynamic number and/or timing of scheduled requests by re-training and/or re-inferring any suitable ARAP model during the authorization request schedule using any new data that may be made available to the system during that authorization request schedule. As just one example, while an authorization request schedule may be active for a particular customer's transaction (e.g., as may have been determined by one or more ARAP models at a first moment in time using first transaction data for the particular customer), in response to negative results of one or more of the scheduled requests of the schedule and/or in response to the particular customer attempting to make a new purchase, such negative results and/or such a new purchase may provide new transaction data that may be used by the system for potentially dynamically updating one or more characteristics of the authorization request schedule (e.g., new BF, new TF, and/or new UF may be provided as new second transaction data for the particular customer that may be provided as new input data into one or more ARAP models for potentially defining a new or updated remainder of the current authorization request schedule (i.e., after the schedule may have been initially defined at the first moment in time)). The use of one or more ARAP models may enable such dynamic updating of one or more characteristics of an authorization request schedule that may be of a limited duration. Such models (e.g., neural networks) running on any suitable processing units (e.g., graphical processing units (“GPUs”) that may be available to SP subsystem 200) provide significant speed improvements in efficiency and accuracy with respect to prediction over other types of algorithms and human-conducted analysis of data, as such models can provide estimates in a few milliseconds or less, thereby improving the functionality of any computing device on which they may be run. Due to such efficiency and accuracy, such models enable a technical solution for enabling in-schedule dynamic updating of schedule characteristics (e.g., number and/or timing of requests) using any suitable real-time data (e.g., data made available to the models during the schedule) that may not be possible without the use of such models, as such models may increase performance of their computing device(s) by requiring less memory, providing faster response times, and/or increased accuracy and/or reliability. Due to the condensed time frame of an authorization request schedule and/or the time within which a decision with respect to a characteristic of an authorization request schedule ought to be made to provide a desirable customer experience, such models offer the unique ability to provide accurate determinations with the speed necessary to enable accurate decisions for initially defining a schedule and/or dynamic adjustments to an active schedule. Such models may enable a data-driven model for customizing an authorization request schedule as opposed to a pre-defined authorization request schedule, a dynamically refreshable active authorization request schedule as opposed to a static authorization request schedule, and/or a utility probability based authorization request schedule as opposed to a purely rule-based authorization request schedule.

CM subsystem 300 may be provided by any suitable credential manager that may manage any funding account on behalf of a customer and/or that may provide a customer with any suitable customer transaction credential that may be used to identify to a service provider an associated funding account from which funds may be transferred to an account of the service provider in exchange for any suitable goods and/or services of the service provider. CM subsystem 300 may include a payment network subsystem (e.g., a payment card association or a credit card association) and/or an issuing bank subsystem and/or any other suitable type of subsystem. A specific customer transaction credential that may be used during a service transaction with SP subsystem 200 may be associated with a specific funding account of a particular user with CM subsystem 300 (e.g., accounts for various types of payment cards may include credit cards, debit cards, charge cards, stored-value cards (e.g., transit cards), fleet cards, gift cards, and the like). Such a customer transaction credential may be provisioned on device 100 (e.g., as CM credential information of an applet on a secure credential component (e.g., NFC component, secure element, and/or the like) of device 100) by CM subsystem 300 and may later be used by device 100 as at least a portion of a service transaction order communicated to SP subsystem 200 for funding a transaction between a customer and SP subsystem 200 (e.g., to pay for a good or service of the SP of SP subsystem 200). Alternatively, such a customer transaction credential may be provided to a customer as a physical credential card or any suitable credential information that may be relayed by the customer to an SP (e.g., over the telephone or via manual entry into a web form), which may be used by the SP for funding a service transaction.

SP subsystem 200 may be provided by any suitable service provider that may utilize customer transaction credential data to facilitate a service transaction for providing any suitable goods and/or services to a customer or another entity or device of the customer's choosing. As just one example, SP subsystem 200 may be provided by Apple Inc. of Cupertino, Calif., which may be a provider of various services to users of device 100 (e.g., the iTunes™ Store for selling/renting media to be played by device 100, the Apple App Store™ for selling/renting applications for use on device 100, the Apple Music™ Service for providing a subscription streaming service, the Apple iCloud™ Service for storing data from device 100 and/or associating multiple user devices and/or multiple user profiles with one another, the Apple Online Store for buying various Apple products online, etc.), and which may also be a provider, manufacturer, and/or developer of device 100 itself (e.g., when device 100 is an iPod™, iPad™, iPhone™, or the like) and/or of an operating system (e.g., device application 103) of device 100. As another example, SP subsystem 200 may be provided by a restaurant or a movie theater or an airline or a car dealership or any other suitable SP entity. The SP that may provide SP subsystem 200 (e.g., Apple Inc.) may be distinct and independent from any CM of any remote CM subsystem 300 (e.g., any funding entity of any remote funding subsystem, any financial institution entity of any remote financial institution subsystem, etc.). For example, the SP that may provide SP subsystem 200 may be distinct and/or independent from any payment network or issuing bank that may furnish and/or manage any credit card or any other customer transaction credential and/or customer payment credential and/or customer funding credential to be used by a customer for funding a service transaction with SP subsystem 200.

Communication of any suitable data between electronic device 100 and CM subsystem 300 may be enabled via any suitable communications set-up 95, which may include any suitable wired communications path, wireless communications path, or combination of two or more wired and/or wireless communications paths using any suitable communications protocol(s) and/or any suitable network and/or cloud architecture(s). Additionally or alternatively, communication of any suitable data between SP subsystem 200 and CM subsystem 300 may be enabled via any suitable communications set-up 95. Additionally or alternatively, communication of any suitable data between electronic device 100 and SP subsystem 200 that may not be made via CM subsystem 300 may be enabled via any suitable communications set-up 95. Communications set-up 95 may be at least partially managed by one or more trusted service managers (“TSMs”). Any suitable circuitry, device, system, or combination of these (e.g., a wired and/or wireless communications infrastructure that may include one or more communications towers, telecommunications servers, or the like) that may be operative to create a communications network may be used to provide at least a portion of communications set-up 95, which may be capable of providing communications using any suitable wired or wireless communications protocol. For example, communications set-up 95 may support Wi-Fi (e.g., an 802.11 protocol), ZigBee (e.g., an 802.15.4 protocol), WiDi™, Ethernet, Bluetooth™, BLE, high frequency systems (e.g., 900 MHz, 2.4 GHz, and 5.6 GHz communication systems), infrared, TCP/IP, SCTP, DHCP, HTTP, BitTorrent™, FTP, RTP, RTSP, RTCP, RAOP, RDTP, UDP, SSH, WDS-bridging, any communications protocol that may be used by wireless and cellular telephones and personal e-mail devices (e.g., GSM, GSM plus EDGE, CDMA, OFDMA, HSPA, multi-band, etc.), any communications protocol that may be used by a low power Wireless Personal Area Network (“6LoWPAN”) module, any other communications protocol, or any combination thereof.

### Description of FIG. 2

As shown in FIG. 2, for example, electronic device 100 may be any suitable electronic device that may interface with SP subsystem 200 in any suitable manner, such as via any suitable online resource, for enabling a customer user to attempt a new purchase for a service transaction with the SP and/or that may interface with CM subsystem 300 in any suitable manner, such as via any suitable online resource, for enabling a customer user to review previous transactions made with a transaction credential of the CM. For example, electronic device 100 may include, but is not limited to, a media player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet (e.g., an iPad™ available by Apple Inc.), server, etc.), monitor, television, stereo equipment, set up box, set-top box, boom box, modem, router, printer, watch, biometric monitor, or any combination thereof. In some embodiments, electronic device 100 may perform a single function (e.g., a device dedicated to interfacing with remote subsystems via online resources) and, in other embodiments, electronic device 100 may perform multiple functions (e.g., a device that interfaces with remote subsystems via online resources and that manages a media library, plays music, and receives and transmits telephone calls). Electronic device 100 may be any portable, mobile, hand-held, or miniature electronic device that may be configured to interface with SP subsystem 200 and/or CM subsystem 300 wherever a user travels. Some miniature electronic devices may have a form factor that is smaller than that of hand-held electronic devices, such as an iPod™. Illustrative miniature electronic devices can be integrated into various objects that may include, but are not limited to, watches (e.g., an Apple Watch™ available by Apple Inc.), rings, necklaces, belts, accessories for belts, headsets, accessories for shoes, virtual reality devices, glasses, other wearable electronics, accessories for sporting equipment, accessories for fitness equipment, key chains, or any combination thereof. Alternatively, electronic device 100 may not be portable at all, but may instead be generally stationary.

As shown in FIG. 2, for example, electronic device 100 may include processing circuitry 102, memory 104, power supply circuitry 106, input component circuitry 108, output component circuitry 110, sensor circuitry 112, and communications circuitry 114. Electronic device 100 may also include a bus 115 that may provide one or more wired or wireless communication links or paths for transferring data and/or power to, from, or between various other components of device 100. In some embodiments, one or more components of electronic device 100 may be combined or omitted. Moreover, electronic device 100 may include any other suitable components not combined or included in FIG. 2 and/or several instances of the components shown in FIG. 2. For the sake of simplicity, only one of each of the components is shown in FIG. 2.

Memory 104 may include one or more storage mediums, including, for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may be fixedly embedded within electronic device 100 or may be incorporated onto one or more suitable types of cards that may be repeatedly inserted into and removed from electronic device 100 (e.g., a subscriber identity module (“SIM”) card or secure digital (“SD”) memory card). Memory 104 may store media data (e.g., music and image files), software (e.g., for implementing functions on device 100), firmware, media information (e.g., media content and/or associated metadata), preference information (e.g., media playback preferences), lifestyle information (e.g., food preferences), exercise information (e.g., information obtained by exercise monitoring equipment or any suitable sensor circuitry), transaction information (e.g., information such as credit card information or other transaction credential information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, pass information (e.g., transportation boarding passes, event tickets, coupons, store cards or other transaction credentials (e.g., financial payment cards), etc.), any suitable model data of device 100 (e.g., as may be stored in any suitable device model 105 of memory assembly 104 (e.g., any portion or all of one, some, or each model of SP subsystem 200 or otherwise as may be described herein)), any other suitable data, or any combination thereof.

Power supply circuitry 106 can include any suitable circuitry for receiving and/or generating power, and for providing such power to one or more of the other components of electronic device 100. For example, power supply circuitry 106 can be coupled to a power grid (e.g., when device 100 is not acting as a portable device or when a battery of the device is being charged at an electrical outlet with power generated by an electrical power plant). As another example, power supply circuitry 106 can be configured to generate power from a natural source (e.g., solar power using solar cells). As another example, power supply circuitry 106 can include one or more batteries for providing power (e.g., when device 100 is acting as a portable device). For example, power supply circuitry 106 can include one or more of a battery (e.g., a gel, nickel metal hydride, nickel cadmium, nickel hydrogen, lead acid, or lithium-ion battery), an uninterruptible or continuous power supply (“UPS” or “CPS”), and circuitry for processing power received from a power generation source (e.g., power generated by an electrical power plant and delivered to the user via an electrical socket or otherwise).

One or more input components 108 may be provided to permit a user to interact or interface with device 100. For example, input component circuitry 108 can take a variety of forms, including, but not limited to, a touch pad, dial, click wheel, scroll wheel, touch screen, one or more buttons (e.g., a keyboard), mouse, joy stick, track ball, microphone, still image camera, video camera, scanner (e.g., a bar code scanner or any other suitable scanner that may obtain product identifying information from a code, such as a bar code, or the like), proximity sensor, light detector, biometric sensor (e.g., a fingerprint reader or other feature recognition sensor, which may operate in conjunction with a feature-processing application that may be accessible to electronic device 100 for authenticating a user), line-in connector for data and/or power, and combinations thereof. Each input component 108 can be configured to provide one or more dedicated control functions for making selections or issuing commands associated with operating device 100.

Electronic device 100 may also include one or more output components 110 that may present information (e.g., graphical, audible, and/or tactile information) to a user of device 100. For example, output component circuitry 110 of electronic device 100 may take various forms, including, but not limited to, audio speakers, headphones, line-out connectors for data and/or power, visual displays, infrared ports, tactile/haptic outputs (e.g., rumblers, vibrators, etc.), and combinations thereof. As a particular example, electronic device 100 may include a display output component as output component 110, where such a display output component may include any suitable type of display or interface for presenting visual data to a user. A display output component may include a display embedded in device 100 or coupled to device 100 (e.g., a removable display). A display output component may include display driver circuitry, circuitry for driving display drivers, or both, and such a display output component can be operative to display content (e.g., media playback information, application screens for applications implemented on electronic device 100, information regarding ongoing communications operations, information regarding incoming communications requests, device operation screens, etc.) that may be under the direction of processor 102.

It should be noted that one or more input components and one or more output components may sometimes be referred to collectively herein as an input/output (“I/O”) component or I/O circuitry or I/O interface (e.g., input component 108 and output component 110 as I/O component or I/O interface 109). For example, input component 108 and output component 110 may sometimes be a single I/O component 109, such as a touch screen, that may receive input information through a user's touch (e.g., multi-touch) of a display screen and that may also provide visual information to a user via that same display screen.

Sensor circuitry 112 may include any suitable sensor or any suitable combination of sensors operative to detect movements of electronic device 100 and/or any other characteristics of device 100 or its environment (e.g., physical activity or other characteristics of a user of device 100). For example, sensor circuitry 112 may include any suitable sensor(s), including, but not limited to, one or more of a GPS sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. In some examples, a biometric sensor may include, but is not limited to, one or more health-related optical sensors, capacitive sensors, thermal sensors, electric field (“eField”) sensors, and/or ultrasound sensors, such as photoplethysmogram (“PPG”) sensors, electrocardiography (“ECG”) sensors, galvanic skin response (“GSR”) sensors, posture sensors, stress sensors, photoplethysmogram sensors, and/or the like. While specific examples are provided, it should be appreciated that other sensors can be used and other combinations of sensors can be combined into a single device. In some examples, a GPS sensor or any other suitable location detection component(s) of device 100 can be used to determine a user's location and movement, as well as a displacement of the user's motion.

Communications circuitry 114 may be provided to allow device 100 to communicate with one or more other electronic devices or servers using any suitable communications protocol (e.g., with CM subsystem 300 and/or with SP subsystem 200 using communications set-up 95). For example, communications circuitry 114 may support Wi-Fi™ (e.g., an 802.11 protocol), ZigBee™ (e.g., an 802.15.4 protocol), WiDi™, Ethernet, Bluetooth™, Bluetooth™ Low Energy (“BLE”), high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, Near Field Communication (“NFC”), any other communications protocol, or any combination thereof. Communications circuitry 114 may also include or be electrically coupled to any suitable transceiver circuitry that can enable device 100 to be communicatively coupled to another device (e.g., a host computer or an accessory device) and communicate with that other device wirelessly, or via a wired connection (e.g., using a connector port). Communications circuitry 114 may be configured to determine a geographical position of electronic device 100. For example, communications circuitry 114 may utilize the global positioning system (“GPS”) or a regional or site-wide positioning system that may use cell tower positioning technology or Wi-Fi™ technology.

Processing circuitry 102 of electronic device 100 may include any processing circuitry that may be operative to control the operations and performance of one or more components of electronic device 100. For example, processor 102 may receive input signals from any input component 108 and/or sensor circuitry 112 and/or communications circuitry 114 and/or drive output signals through any output component 110 and/or communications circuitry 114. As shown in FIG. 2, processor 102 may be used to run at least one application 103. Application 103 may include, but is not limited to, one or more operating system applications, firmware applications, software applications, third party applications (e.g., applications managed by the SP of SP subsystem 200, the CM of CM subsystem 300, and/or the like), online resource applications, algorithmic modules, media analysis applications, media playback applications, media editing applications, communications applications, pass applications, calendar applications, social media applications, state determination applications, biometric feature-processing applications, activity monitoring applications, activity motivating applications, and/or any other suitable applications. For example, processor 102 may load application 103 as a user interface program to determine how instructions or data received via an input component 108 and/or any other component of device 100 may manipulate the one or more ways in which information may be stored and/or provided to the user via an output component 110 and/or any other component of device 100. Any application 103 may be accessed by any processing circuitry 102 from any suitable source, such as from memory 104 (e.g., via bus 115) and/or from another device or server (e.g., from CM subsystem 300 and/or from SP subsystem 200 (e.g., via an active internet connection (e.g., via communications circuitry 114))). For example, application 103 may be any suitable internet browsing application (e.g., for interacting with a website provided by CM subsystem 300 and/or by SP subsystem 200 for enabling device 100 to interact with an online service of CM subsystem 300 and/or SP subsystem 200), any suitable CM application (e.g., a web application or a native application that may be at least partially produced by CM subsystem 300 for enabling device 100 to interact with an online service of CM subsystem 300), any suitable SP application (e.g., a web application or a native application that may be at least partially produced by SP subsystem 200 for enabling device 100 to interact with an online service of SP subsystem 200), or any other suitable applications. As one example, an application 103 may provide a user with the ability to interact with a service or platform of CM subsystem 300, where such an application 103 may be a third party application that may be running on device 100 (e.g., an application associated with CM subsystem 300 that may be loaded on device 100 from CM subsystem 300 or via an application market (e.g., from SP subsystem 200 if a media market SP) and/or that may be accessed via an internet application or web browser running on device 100 (e.g., processor 112) that may be pointed to a uniform resource locator (“URL”) whose target or web resource may be managed by CM subsystem 300 (e.g., running on a server of CM subsystem 300) or any other remote subsystem). Therefore, application 103 may be configured to provide a CM online resource, such as a website or native online application, for presentation of a CM interface to a user on device 100. As another example, an application 103 may provide a user with the ability to interact with a service or platform of SP subsystem 200, where such an application 103 may be a third party application that may be running on device 100 (e.g., an application associated with SP subsystem 200 that may be loaded on device 100 from SP subsystem 200 or via an application market (e.g., from SP subsystem 200 if a media market SP) and/or that may be accessed via an internet application or web browser running on device 100 (e.g., processor 112) that may be pointed to a uniform resource locator (“URL”) whose target or web resource may be managed by SP subsystem 200 (e.g., running on a server of SP subsystem 200) or any other remote subsystem). Therefore, application 103 may be configured to provide an SP online resource, such as a website or native online application, for presentation of a SP interface to a user on device 100. In a particular example, as shown in FIG. 2, processor 102 may be used to run a first application 103 that may be an operating system application and a second application 103a that may be a third party application or any other suitable online resource (e.g., an application associated with a service provider of SP subsystem 200 (e.g., a media store, an app store, etc.) or an application associated with a credential manager of CM subsystem 300 (e.g., credential manager app, etc.)). Moreover, processor 102 may have access to device identification information 119, which may be utilized to provide identification of device 100 (e.g., identification of the particular device 100 and/or identification of the type of device 100 (e.g., make and/or model and/or the like) to a remote subsystem (e.g., a unique device identification to SP subsystem 200 and/or to CM subsystem 300)) (e.g., such that certain device information may be securely and confidentially shared with one or more of subsystems 200 and 300 (e.g., the location of device 100 and/or the usage of an SP media application on device 100, etc.)). Processor 102 may include a single processor or multiple processors. For example, processor 102 may include at least one “general purpose” microprocessor, a combination of general and special purpose microprocessors, instruction set processors, graphics processors, video processors, communications processors, motion processors, biometric processors, application processors, and/or related chips sets, and/or special purpose microprocessors. Processor 102 also may include on board memory for caching purposes.

Although not shown, device 100 may include any suitable secure credential component (e.g., NFC component, secure element, and/or the like) that may include or otherwise be configured to provide a tamper-resistant platform (e.g., as a single-chip or multiple-chip secure microcontroller) that may be capable of securely hosting applications and their confidential and cryptographic data in accordance with rules and security requirements that may be set forth by a set of well-identified trusted authorities (e.g., an authority of SP subsystem 200 and/or of CM subsystem 300 and/or of an industry standard, such as GlobalPlatform). Any suitable customer transaction credential information, such as CM credential information, may be stored in an applet on such a secure credential component of device 100 and may be configured to provide customer transaction credential data for use in any suitable service transaction order with a remote entity subsystem, such as SP subsystem 200. For example, the customer transaction credential data may provide an actual value source and/or may provide sufficient detail for identifying a funding account of CM subsystem 300 that may be used to as a value source, and the value source may be used to at least partially fund a service transaction between electronic device 100 and SP subsystem 200 for any suitable service provider service (e.g., any suitable good or service that may be provided on behalf of SP subsystem 200 for the benefit of a user of electronic device 100).

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 108 may be an independent keyboard or mouse within its own housing that may wirelessly or through a wire communicate with processor 102, which may be provided within its own housing).

Although not shown, SP subsystem 200 may also include a processor component that may be the same as or similar to processor component 102 of electronic device 100, a communications component that may be the same as or similar to communications component 114 of electronic device 100, an I/O interface that may be the same as or similar to I/O interface 109 of electronic device 100, a bus that may be the same as or similar to bus 115 of electronic device 100, a memory component that may be the same as or similar to memory 104 of electronic device 100, and/or a power supply component that may be the same as or similar to power supply 106 of electronic device 100.

Although not shown, CM subsystem 300 may also include a processor component that may be the same as or similar to processor component 102 of electronic device 100, a communications component that may be the same as or similar to communications component 114 of electronic device 100, an I/O interface that may be the same as or similar to I/O interface 109 of electronic device 100, a bus that may be the same as or similar to bus 115 of electronic device 100, a memory component that may be the same as or similar to memory 104 of electronic device 100, and/or a power supply component that may be the same as or similar to power supply 106 of electronic device 100.

### Description of FIG. 3

As shown in FIG. 3, one specific example of electronic device 100 may be an electronic device, such as an iPhone™, where housing 101 may allow access to various input components 108a-108i, various output components 110a-110c, and various I/O components 109a-109c through which device 100 and a user and/or an ambient environment may interface with each other. Input component 108a may include a button that, when pressed, may cause a “home” screen or menu of a currently running application to be displayed by device 100. Input component 108b may be a button for toggling electronic device 100 between a sleep mode and a wake mode or between any other suitable modes. Input component 108c may include a two-position slider that may disable one or more output components 112 in certain modes of electronic device 100. Input components 108d and 108e may include buttons for increasing and decreasing the volume output or any other characteristic output of an output component 110 of electronic device 100. Each one of input components 108a-108e may be a mechanical input component, such as a button supported by a dome switch, a sliding switch, a control pad, a key, a knob, a scroll wheel, or any other suitable form.

An output component 110a may be a display that can be used to display a visual or graphic user interface (“GUI”) 180, which may allow a user to interact with electronic device 100. A screen 190 of GUI 180 may include various layers, windows, screens, templates, elements, menus, and/or other components of a currently running application (e.g., application 103) that may be displayed in all or some of the areas of display output component 110a. One or more of user input components 108a-108i may be used to navigate through GUI 180. For example, one user input component 108 may include a scroll wheel that may allow a user to select one or more graphical elements or icons 182 of GUI 180. Icons 182 may also be selected via a touch screen I/O component 109a that may include display output component 110a and an associated touch input component 108f. Such a touch screen I/O component 109a may employ any suitable type of touch screen input technology, such as, but not limited to, resistive, capacitive, infrared, surface acoustic wave, electromagnetic, or near field imaging. Furthermore, touch screen I/O component 109a may employ single point or multi-point (e.g., multi-touch) input sensing.

Icons 182 may represent various applications, layers, windows, screens, templates, elements, and/or other components that may be displayed in some or all of the areas of display component 110a upon selection by the user. Furthermore, selection of a specific icon 182 may lead to a hierarchical navigation process. For example, selection of a specific icon 182 may lead from screen 190 of FIG. 3 to a new screen of GUI 180 that may include one or more additional icons or other GUI elements of the same application or of a new application associated with that icon 182. Textual indicators 181 may be displayed on or near each icon 182 to facilitate user interpretation of each graphical element icon 182. It is to be appreciated that GUI 180 may include various components arranged in hierarchical and/or non-hierarchical structures. When a specific icon 182 is selected, device 100 may be configured to open a new application associated with that icon 182 and display a corresponding screen of GUI 180 associated with that application. As an example, when the specific icon labeled with a “Calendar” textual indicator is selected, device 100 may launch or otherwise access a specific calendar or reminder application and may display screens of a specific user interface that may include one or more tools or features for interacting with one or more events or other reminders that may be time-sensitive in a specific manner. As another example, when the specific icon labeled with a “Credential Manager” textual indicator is selected, device 100 may launch or otherwise access a specific CM application (e.g., CM online resource) and may display screens of a specific user interface that may include one or more tools or features for interacting with CM subsystem 300 in a specific manner. As another example, when the specific icon labeled with a “Wallet” textual indicator is selected, device 100 may launch or otherwise access a specific pass or wallet application and may display screens of a specific user interface that may include one or more tools or features for interacting with one or more passes or other credentials (e.g., payment credentials of an NFC and/or secure element component of device 100) in a specific manner. For each application, screens may be displayed on display output component 110a and may include various user interface elements. Additionally or alternatively, for each application, various other types of non-visual information may be provided to a user via various other output components 110 of device 100.

Electronic device 100 also may include various other I/O components 109 that may allow for communication between device 100 and other devices, such as a connection port 109b that may be configured for transmitting and receiving data files, such as media files or customer order files, and/or any suitable information (e.g., audio signals) from a remote data source and/or power from an external power source. For example, I/O component 109b may be any suitable port (e.g., a Lightning™ connector or a 30-pin dock connector available by Apple Inc.). I/O component 109c may be a connection slot for receiving a SIM card or any other type of removable component. Electronic device 100 may also include at least one audio input component 109g, such as a microphone, and at least one audio output component 110b, such as an audio speaker. Electronic device 100 may also include at least one tactile output component 110c (e.g., a rumbler, vibrator, haptic and/or taptic component, etc.), a camera and/or scanner input component 108h (e.g., a video or still camera, and/or a bar code scanner or any other suitable scanner that may obtain product identifying information from a code, such as a bar code, or the like), and a biometric input component 108i (e.g., a fingerprint reader or other feature recognition sensor, which may operate in conjunction with a feature-processing application that may be accessible to electronic device 100 for authenticating a user).

### Description of FIGS. 4 and 5

Referring now to FIG. 4, FIG. 4 shows further details with respect to particular embodiments of SP subsystem 200 of system 1. As shown in FIG. 4, SP subsystem 200 may be a secure platform system and may include a secure mobile platform (“SMP”) broker component 240, an SMP trusted services manager (“TSM”) component 250, an SMP crypto services component 260, an identity management system (“IDMS”) component 270, a fraud system component 280, a hardware security module (“HSM”) component 290, a store component 265, and/or one or more servers 210. One, some, or all components of SP subsystem 200 may be implemented using one or more processor components, which may be the same as or similar to processor circuitry 102 of device 100, one or more memory components, which may be the same as or similar to memory 104 of device 100, and/or one or more communications components, which may be the same as or similar to communications circuitry 114 of device 100. Any suitable communication protocol or combination of communication protocols may be used by SP subsystem 200 to communicate data amongst the various components of SP subsystem 200 (e.g., via at least one communications path 295 of FIG. 4) and/or to communicate data between SP subsystem 200 and other components of system 1 (e.g., CM subsystem 300 and/or electronic device 100). One, some, or all components of SP subsystem 200 may be managed by, owned by, at least partially controlled by, and/or otherwise provided by or for a single SP (e.g., Apple Inc.) that may be distinct and independent from any CM subsystem 300. The components of SP subsystem 200 may interact with each other and collectively with any suitable CM subsystem 300 and/or electronic device 100 for facilitating one or more service transactions and/or for training, inferring, managing, or otherwise using one or more ARAP models for customizing the use of one or more authorization request schedules for one or more customers.

SMP broker component 240 of SP subsystem 200 may be configured to manage customer authentication with an SP customer account of SP subsystem 200 and/or to manage CM validation with a CM subsystem account of SP subsystem 200. SMP broker component 240 may be a primary end point that may control certain interface elements (e.g., elements of a GUI 180) on device 100. A CM application of CM subsystem 300 may be configured to call specific application programming interfaces (“APIs”) and SMP broker 240 may be configured to process requests of those APIs and respond with data that may derive a portion of a user interface that may be presented by CM subsystem 300 (e.g., to device 100) and/or respond with application protocol data units (“APDUs”) that may communicate with CM subsystem 300. Such APDUs may be received by SP subsystem 200 from CM subsystem 300 via a trusted services manager (“TSM”) of system 1 (e.g., a TSM of a communication path between SP subsystem 200 and CM subsystem 300). In some particular embodiments, SMP TSM component 250 of SP subsystem 200 may be configured to provide Global Platform-based services or any other suitable services that may be used to carry out credential provisioning operations on device 100 from CM subsystem 300. GlobalPlatform, or any other suitable secure channel protocol, may enable SMP TSM component 250 to properly communicate and/or provision sensitive account data between a secure element of device 100 and a TSM for secure data communication between SP subsystem 200 and a remote subsystem.

SMP TSM component 250 may be configured to use HSM component 290 to protect keys and generate new keys. SMP crypto services component 260 of SP subsystem 200 may be configured to provide key management and cryptography operations that may be provided for user authentication and/or confidential data transmission between various components of system 1 (e.g., between SP subsystem 200 and CM subsystem 300 and/or between SP subsystem 200 and device 100 and/or between different components of SP subsystem 200). SMP crypto services component 260 may utilize HSM component 290 for secure key storage and/or opaque cryptographic operations. A payment crypto service of SMP crypto services component 260 may be configured to interact with IDMS component 270 to retrieve information associated with on-file credit cards or other types of customer transaction credentials associated with user accounts of the SP (e.g., an Apple iCloud™ account). Such a payment crypto service may be configured to be the only component of SP subsystem 200 that may have clear text (e.g., non-hashed) information describing customer transaction credentials (e.g., credit card numbers) of its user accounts in memory. Fraud system component 280 of SP subsystem 200 may be configured to run an SP fraud check on a customer transaction credential based on data known to the SP about the transaction credential and/or the customer (e.g., based on data (e.g., customer transaction credential information) associated with a customer account with the SP and/or any other suitable data that may be under the control of the SP and/or any other suitable data that may not be under the control of a remote subsystem). Fraud system component 280 may be configured to determine an SP fraud score for the credential based on various factors or thresholds. Additionally or alternatively, SP subsystem 200 may include store 265, which may be a provider of various services to users of device 100 (e.g., the iTunes™ Store for selling/renting media to be played by device 100, the Apple App Store™ for selling/renting applications for use on device 100, the Apple iCloud™ Service for storing data from device 100 and/or associating multiple user devices and/or multiple user profiles with one another, the Apple Online Store for buying various Apple products online, the Apple Music™ Service for enabling subscriptions of various streaming services, etc.). As just one example, store 265 may be configured to manage and provide an application 103 and/or application 103a to device 100, where the application may be any suitable application, such as a CM application (e.g., a banking application), an SP application (e.g., a music streaming service application), an e-mail application, a text messaging application, an internet application, a credential management application, or any other suitable communication application, and/or to provide any suitable SP product to a customer (e.g., a media file to memory 104 of customer device 100, etc.).

Server 210 may be any suitable server that may be operative to handle any suitable services or functionalities of SP subsystem 200. In other embodiments, at least a portion or the entirety of server 210 may be an independent subsystem distinct from SP subsystem 200 (e.g., as a third party subsystem of a third party that may be distinct from the SP of SP subsystem 200 or as another subsystem provided by the SP of SP subsystem 200 that may be distinct from SP subsystem 200). As shown in FIG. 5, server 210 may be a model management server that may be operative to train, infer, manage, or otherwise use one or more models (e.g., one or more ARAP models) for customizing the use of one or more authorization request schedules for one or more customers of SP subsystem 200. For example, at least one model, such as one or more models 205, may be developed and/or generated for use in determining an appropriate authorization request approval probability for a particular customer's transaction over various potential request times. For example, any or all transaction data 211 available to system 1 (e.g., data indicative of any or all characteristics of any or all transactions previously completed and/or attempted by SP subsystem 200 or otherwise for any customers or subset of customers (e.g., account history, purchase history, authorization history, billing history, and/or the like available to SP subsystem 200 and/or CM subsystem 300 and/or one or more customer devices 100 and/or any other suitable subsystems or data sources accessible by server 210)) may be collected at a data storage (e.g., file system and/or database) 212, and a feature generator 214 may be operative to selectively pull some or all such transaction data 211 from data storage 212 as batch job data 215 into a batch job data storage 216 (e.g., file system and/or database (e.g., a hadoop distributed file system (“HDFS”))), where batch job data 215 may be all transaction data of data 211 that was generated within the last 30 days (e.g., transaction data associated with transactions initiated within the last 30 days) or any other suitable timeframe and/or all transaction data with any other suitable commonality. As shown, for example, data 211 and/or data 215 may include various feature transaction data, including, but not limited to, any suitable UF data, any suitable BF data, any suitable TF data, and/or certain specific types of data that may be used for training an ARAP model or any other suitable type of model for any other suitable purpose, such as “buys_last_x_days” (e.g., number of purchases attempted within last X days by a particular customer associated with a particular transaction data set), “amt_last_x_days” (e.g., total value amount and/or transaction count of all transactions attempted within last X days by a particular customer associated with a particular transaction data set), “sess_last_x_days” (e.g., total number of payment sessions activated within last X days by a particular customer associated with a particular transaction data set), average total value amount per day of all transactions attempted over last X days by a particular customer associated with a particular transaction data set, average minimum value amount per day of all transactions attempted over last X days by a particular customer associated with a particular transaction data set, average maximum value amount per day of all transactions attempted over last X days by a particular customer associated with a particular transaction data set, average number of transactions per day attempted over last X days by a particular customer associated with a particular transaction data set, minimum interval between transactions attempted over last X days by a particular customer associated with a particular transaction data set, maximum interval between transactions attempted over last X days by a particular customer associated with a particular transaction data set, number of billing accounts used over last X days by a particular customer associated with a particular transaction data set, number of successful authorizations over last X days for a particular customer associated with a particular transaction data set, ratio of successful authorizations to all authorization requests over last X days for a particular customer associated with a particular transaction data set, number of in-app purchases (or any particular product or service type of purchase) over last X days by a particular customer associated with a particular transaction data set, list of genres of products or content types purchased over last X days by a particular customer associated with a particular transaction data set, “layers_to_fraudster” (e.g., closeness of customer to another user that has been identified as a fraudster (e.g., as may be determined by a user graph of users connected by one or more shared properties, such as social network relations, geographical distances, internet protocol similarities, SP products of interest/attempted to be purchased similarities, etc.), which may be indicative of a level of suspiciousness attributed to the customer), and/or the like. A model builder 218 may be operative to receive some or all of batch job data 215 from batch job database 216 (or some or all of data 211 from database 212 when generator 214 and/or database 216 may not be used) and to use such data to build (e.g., train) one or more models 205 (e.g., one or more batch job models 217), such as one or more regression models, boosted tree models, neural network models, and/or any other suitable types of models, one or more of which may be trained as a particular type of model (e.g., an ARAP model, etc.).

Some or all models generated or otherwise trained or built by model builder 218 may be collected by a model repository 232, while a best model identifier 234 may be operative to identify the best performing model(s) of model repository 232 using any suitable techniques (e.g., model identifier 234 may identify a best performing model for each one of the various types of models available to system 1 at a particular moment (e.g., a best performing ARAP model, etc.), each of which may be the same or different type of machine learning model). Then, when one or more particular types of model is to be used to customize an authorization request schedule for a particular customer for a particular purchase transaction, a model request server 236 may be operative to receive from any suitable source (e.g., any suitable client source for server 210 (e.g., store 265)) a request 239 for such model(s) that may include model request data 239d (e.g., any suitable transaction data associated with a particular customer and/or a particular transaction of that customer, including, but not limited to, any suitable UF data, BF data, TF data, a “dsid” (e.g., a unique customer identifier for the particular customer and/or a customer score indicative of some trustworthiness or fraud score or otherwise that may be associated with the customer), a “store_front_id” (e.g., an identifier of the particular store that received the transaction purchase attempt from the customer (e.g., a particular app store, a particular music subscription service, etc.)), a “buy_amount” (e.g., a value amount of the SP product(s) to be purchased in the transaction purchase attempt), “buys_last_x_hours” (e.g., number of purchases attempted or authorized for the particular customer during the last X hours), “card_type” (e.g., type of transaction credential being used for the transaction purchase attempt), “flow_step” (e.g., relative operation within a customization flow at which request 239 was generated (e.g., which operation (e.g., operation 608) and/or the like of process 600 of FIG. 6 initiated the request and from which other operation did process 600 arrive at that operation, etc.)), and/or the like (e.g., any suitable type/feature of transaction data that may also be represented by data 211, 215, 221, 225, and/or the like)).

In response to receiving such a request 239, model request server 236 may be operative to use some or all of model request data 239d as input data to one or more of the models available to model request server 236 (e.g., one or more of the best ARAP models of best model identifier 234) in order to receive appropriate model output data 205d (e.g., any suitable model output data that may be used to customize an authorization request schedule experience for the particular customer, including, but not limited to, an authorization request approval probability (“ARAP”) score for each one of any suitable number of potential request times (e.g., a value between 0 (e.g., indicative of a 0% chance of success of the authorization request if made at the particular potential request time) and 1 (e.g., indicative of a 100% chance of success of the authorization request if made at the particular potential request time)) for the particular customer's transaction as may be determined by a best performing ARAP model available to model request server 236 using at least some transaction data of model request data 239d as model input data (e.g., as may be used by operation 608 of process 600)), and/or the like).

Any or all of such model output data 205d that may be received by model request server 236 for a particular request 239 may be provided as at least a portion of any suitable model response data 237d for a model response 237 that may be returned by server 210 to any suitable target (e.g., the client source (e.g., store 265) that may have provided request 239). As shown, in addition to any suitable model output data 205d, model response data 237d may include any suitable additional model response data that may help facilitate customization and/or use of an authorization request schedule for the particular customer's transaction, including, but not limited to, a “dsid” (e.g., the unique customer identifier for the particular customer and/or a customer score indicative of some trustworthiness or fraud score or otherwise that may be associated with the customer (e.g., the same identifier as in request 239, which may facilitate linking request 239 and response 237)), a “timestamp” (e.g., any suitable timestamp indicative of the time at which all or any suitable portion of response data 237d may have been generated and/or the potential time with which a particular ARAP score is associated), a “model_version” (e.g., any suitable data that may be indicative of a particular model of server 210 that may have been used to generate at least a portion of data 205d and/or of a type of such a model and/or the like, which may be used for diagnostic purposes or any other suitable purposes, where such optional data may be exposed to the client and may be useful, for example, when the client would like to determine how and/or when the model output evolved, where an A/B test or experiment or otherwise might be conducted based on such data by the client or otherwise), and/or the like.

As also shown in FIG. 5, server 210 may also include a streaming job set of databases and/or other modules that may be operative to identify certain features/inputs of at least one model that may be of particular significance or importance to the effectiveness of that model. For example, one or more models 205 built by model builder 218 (e.g., one or more batch job models 217) or otherwise available to server 210 may be analyzed in any suitable manner by a feature selector 220 to identify one or more features (e.g., inputs) that have a significant impact on the effectiveness of the model being analyzed (e.g., to determine the input(s) of the model that have the most effect on the output(s) of the model). Then those features of importance (e.g., each feature that reaches a particular importance threshold and/or each one of a particular number of features that are the most important to the model) identified by feature selector 220 for a particular model may be utilized by a streaming job feature generator 224. For example, streaming job feature generator 224 may be operative to selectively pull some or all transaction data 221 from a queue data storage 222 as shortlist or streaming job data 225 into a streaming job data storage (e.g., file system and/or database) 226, where streaming job data 225 may be only the transaction data of transaction data 221 indicative of the features identified by feature selector 220. For example, as shown, data 225 may include various feature transaction data, including, but not limited to, “buys_last_x_days” (e.g., number of purchases attempted within last X days by a particular customer associated with a particular transaction data set), “amt_last_x_days” (e.g., total value amount and/or transaction count of all transactions attempted within last X days by a particular customer associated with a particular transaction data set), “layers_to_fraudster”, and/or the like, but not “sess_lastx_days” (e.g., total number of payment sessions activated within last X days by a particular customer associated with a particular transaction data set), as may be provided by data 215. In some embodiments, data 221 may differ from data 211 in that data 221 may only be transaction data generated within a recent period of time (e.g., real-time or near real-time data that may be made accessible to server 210), such as transaction data generated within the last 5 minutes, or within the last 2 hours or any other suitable batch update refresh period that may otherwise collect new data 211. For example, data 211 and data 221 may differ in any one or more suitable ways, including, but not limited to, length of data processing history (e.g., data 211 may be an archived data processed in the past few days to years, while data 221 may be much more recent data), need for (near) real-time data (e.g., data 211 may have much longer latency than data 221), storage location/database (e.g., data 211 may be stored in a file system (e.g., distributed file system) or transaction database while data 221 may be stored in a queue platform with data low-latency, such as Apache Kafka), and/or the like. Then, a streaming job model builder 228 may be operative to receive some or all of the models built by batch job model builder 218 (e.g., one or more models 205 (e.g., one or more batch job models 217) via feature selector 220) as well as streaming job data 225 from streaming job database 226 (or some or all of data 221 from database 222 when generator 224 and/or database 226 may not be used) and to use such data to further build (e.g., re-train or further train or refresh) one or more the received models 205 (e.g., one or more batch job models 217) (e.g., as one or more updated or re-trained or refreshed streaming job models 227), and each re-trained or updated model may be provided via model updater 230 to model repository 232.

Therefore, streaming job model builder 228 may be operative to update one or more batch job models using only particular feature types of transaction data 225 from data 221 of queue database 222, where such updating by builder 228 may be accomplished with limited overhead and/or limited processing in a more efficient manner (e.g., as only a limited set of features of a limited set of transaction data may be used to retrain one or more models). Thus, modules 220, 222, 224, 226, 228, and/or 230 may be operative to update and/or improve the training of one or more models based on real-time or near-real time data in an efficient manner (e.g., by focusing on only certain features of transaction data that may be of significant importance to the effectiveness of the model(s) and/or by only using newly generated transaction data). This may enable a certain type of model, such as an ARAP model, to be re-trained or otherwise refreshed using transaction data generated or otherwise first made available to server 210 (e.g., via data 221) during an active authorization request schedule for which that refreshed model may then be used to make a determination on an updated characteristic (e.g., an updated probability) for that active authorization request schedule (e.g., at operation 608 of process 600 (e.g., periodically and/or in response to any new relevant transaction data being received for the particular customer)).

Any suitable API(s) may be used between any two communicating entities of system 1. Store 265 may call an API endpoint with a request 239 to retrieve a response, and the API response to the call may be a response 237 from server 210. Additionally or alternatively, server 210 may call an API endpoint with a request for any suitable data 211 and/or data 332 from any suitable data source, and the API response to the call may be any suitable transaction data 211 and/or 221 or otherwise from any suitable data source.

Thus, one or more models 205 managed by server 210 may be operative to effectively and efficiently determine an appropriate authorization request schedule for a particular customer in a particular transaction situation. For example, such a model or learning engine may include any suitable neural network (e.g., an artificial neural network) that may be initially configured, trained on one or more sets of scored (e.g., authorized and/or rejected) transaction data for one or more past transactions (e.g., individual and/or aggregated transactions by any customers or particular customer(s)), and then used to predict an appropriate characteristic or eligibility or authorization request approval probability of a customized authorization request schedule experience for a particular customer in a particular transaction situation.

A neural network or neuronal network or artificial neural network or any other suitable type of model for use in managing one or more models may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

Different input neurons of the neural network may be associated with respective different types of features or categories of transaction data and may be activated by transaction feature data of the respective transaction feature (e.g., each possible category or feature of BF transaction data, each possible category or feature of UF transaction data, each possible category or feature of TF transaction data, each possible category or feature of graph based transaction data, and/or the like may be associated with one or more particular respective input neurons of the neural network and transaction feature data for the particular transaction feature may be operative to activate the associated input neuron(s)). The weight assigned to the output of each neuron may be initially configured using any suitable determinations that may be made by a custodian or processor of the model (e.g., server 210) based on the data available to that custodian.

The initial configuring of the learning engine or model (e.g., the initial weighting and arranging of neurons of a neural network of the learning engine) may be done using any suitable data accessible to a custodian of the model. For example, a model custodian may be operative to capture any suitable initial background data about a particular customer or all known customers or a subset of all known customers or all known transactions or a subset of all known transactions as well as the result or truth for each transaction (e.g., authorized or rejected) in any suitable manner from any suitable sources (e.g., SP subsystem 200, one or more CM subsystems 300, one or more customer devices 100, one or more third party subsystems, or the like). Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network. A loop (e.g., a receipt and train loop) of receiving transaction feature data and a result/truth for a transaction and then training the model using the received transaction feature data and result/truth may be repeated any suitable number of times for more effectively training the learning engine, where the received transaction feature data and the received result/truth received of different receipt and train loops may be for different customers or for the same customer (e.g., for different transactions) and/or may be received from the same source or from different sources. The number and/or type(s) of the one or more types of transaction features for which transaction feature data may be received for one receipt and train loop may be the same or different in any way(s) than the number and/or type(s) of the one or more transaction features for which transaction feature data may be received for a second receipt and train loop.

### Description of FIG. 6

FIG. 6 is a flowchart of an illustrative process 600 for customizing an authorization request schedule for a particular customer's transaction. At operation 601, as described above, at least one ARAP model (e.g., ARAPM 601m of FIG. 5) may be trained using any number of appropriate combinations of suitable model input features of a historical transaction authorization request attempt as training inputs (e.g., UF data, BF data, TF data, etc.) and the resulting label of the historical transaction authorization request attempt as a training output (e.g., rejected (e.g., value 0) or successful (e.g., value 1)). At operation 602, it may be determined whether the particular customer's transaction is up for a scheduled payment (e.g., whether a transaction due date associated with a particular transaction (e.g., the moment that a monthly subscription service is due to be up for renewal) is soon or has arrived). If no, operation 602 may repeat itself until a transaction due date is determined to be imminent or present at operation 602, in response to which process 600 may proceed from operation 602 to operation 604. At operation 604, any or all online features (e.g., new customer data (e.g., model input feature data for the particular customer transaction) and/or the like) and/or any or all offline features (e.g., historical customer data and/or any appropriate trained ARAP model(s) and/or statistical rules and/or business rules, etc.) may be aggregated for carrying out the remainder of process 600. At operation 606, a set of all potential request times (e.g., time t1 through time tT) of any suitable interval for any suitable grace period associated with the transaction due date of the transaction may be identified. For example, a grace period of 10 days starting at the transaction due date may be identified for setting the boundaries of a set of potential request times occurring every hour of the grace period such that a particular set of 240 potential request times (e.g., where T is 240) may be identified at operation 606. The grace period may be any suitable duration of time (e.g., 3 days, 5 days, 7 days, 10 days, 14 days, etc.) that may begin at any suitable moment with respect to the transaction due date (e.g., at 12:00 AM on the transaction due date, at 12:00 AM on the first Monday following the transaction due date, one day prior to the transaction due date, etc.), where the duration of the grace period and/or its start time's relationship to the transaction due date may vary based on any suitable characteristic of the transaction (e.g., a risk factor associated with the transaction's customer, the value amount of the transaction, the usage by the customer of the underlying SP product, any suitable UF, BF, TF, and/or the like) or may be static for all customer transactions. The interval between potential request times within a grace period (e.g., number of potential request times of a grace period) may be any suitable duration of time (e.g., 1 minute, 10 minutes, 30 minutes, 1 hour, 6 hours, 12 hours, 24 hours, etc.), where the duration of the interval may vary based on any suitable characteristic of the transaction (e.g., a risk factor associated with the transaction's customer, the value amount of the transaction, the usage by the customer of the underlying SP product, any suitable UF, BF, TF, and/or the like) or may be static for all customer transactions.

At operation 608, an ARAP model may be utilized to predict an ARAP (e.g., an ARAP score) for each potential request time for the particular transaction (e.g., using any suitable ARAPM 601m of server 210 (e.g., as trained at operation 601) using any suitable request 239 and response 237 communications between store 265 and server 210 (e.g., using any suitable transaction feature data that may be specific to the particular customer and/or the particular transaction for which a schedule is being customized (e.g., “dsid” and/or “store_front_id” and/or “buy_amount” and/or “buys_last_x_hours” and/or “card_type” and/or “flow_step” and/or “model_version” and/or any suitable BF and/or any suitable TF and/or any suitable UF and/or the like))). For example, at operation 608, various suitable model input features of the particular transaction and for a particular potential request time may be provided as inputs to a previously trained ARAP model, where such model input features may include one or more various types of UF data, BF data, and/or TF data associated with the particular transaction and a particular potential request time t, and the ARAP model may be operative to provide an output probability P(t) based on those model input features, where such output probability P may be any suitable value between 0 and 1 for that particular transaction at that particular potential request time (e.g., the model may be operative to compute an output probability P(t) of a value 0 that may be indicative of a prediction of a 0% probability of success for an authorization request made at the particular potential request time t, an output probability P(t) of a value 1 that may be indicative of a prediction of a 100% probability of success for an authorization request made at the particular potential request time t, or an output probability P(t) of any value between 0 and 1 that may be indicative of a prediction of any other suitable percentage probability of success for an authorization request made at the particular potential request time t). Operation 608 may be carried out to generate such an output probability P(t) for every potential request time t identified at operation 606.

At operations 610-620, process 600 may be operative to use a statistical model (e.g., statistical model SM 610m) that may be operative to calculate an expected gain for attempting an authorization request at each potential request time t using the output probability P(t) predicted at operation 608 for every potential request time t identified at operation 606 in conjunction with one or more cost constraints. For example, an expected gain E to be realized by the SP subsystem if an authorization request were to be made at a particular potential request time t (i.e., E(t)) may be defined to equal P(t)*A−F+(1−P(t))*E(t+1), where A may be the amount to be paid to the SP subsystem if the authorization request were successful (e.g., the purchase price for the transaction), and where F may be the overhead cost (e.g., transaction cost and/or operation cost) incurred by the SP subsystem for making an authorization request, and where E(t+1) may be the expected gain calculated for a particular request time t+1 that may be consecutively after the particular request time t. Therefore, the expected gain E(t) for a particular time t may be defined to be dependent on a future expected gain with respect to that particular time f (e.g., dependent on the expected gain at time t+1 (i.e., E(t+1))). This may be why the expected gain calculation may first be made from the last time tT and then calculated in reverse order by time (e.g., an initial potential request time t that may be selected for use at an initial iteration of operation 610 may be time tT, and then the next future iteration of operation 610 (e.g., after operation 619) may select time tT−1). For example, A may be $10.00 and F may be $1.00, such that if P(t) was predicted to be 0.4 by the ARAP model, and such that if E(t+1) may be determined to be $5.00, then the expected gain E(t) may be determined by the statistical model to be $6.00. While the ARAP model may be trained over a long period of time using a lot of historical data based on the success or failure of many past authorization requests, the statistical model's use of various cost values (e.g., A, F, or any other suitable cost variables) and/or the values of those various cost values (e.g., $10.00, $1.00, etc.) may be updated at any suitable moment (e.g., as costs associated with authorization requests and values of various transactions may change in many ways at any suitable time). Therefore, the combination of two distinct models, such as an ARAP model and a statistical model, for determining an expected gain at a particular potential request time may provide a hybrid model solution that enables the customization of an ARAP model with the ability to easily fine tune and adjust characteristics of a statistical model. In some embodiments, the expected gain peaks throughout the potential request times of the grace period may be identified, and only the peaks may be added (e.g., at operation 616) to the customized authorization request schedule (e.g., at various iterations of operation 616), where an expected gain peak may be identified as a request at a potential request time t, where E(t) (e.g., as determined at operation 610) is not less than or is greater than each one of E(t+1) and E(t−1) (e.g., as determined at operations 612 and 614).

In some embodiments, after each one of E(t) and E(t+1) has been calculated (e.g., at operations 610 and 612, respectively, for a selected potential request time t), a determination may be made (e.g., at operation 614) as to which of the following two expected values is greater: (i) E(t) or (ii) E(t+1), and, if (i) is determined to be greater than (ii), then process 600 may proceed from operation 614 to operation 616 where potential request time t may be added to an initial customized authentication request schedule before proceeding to operation 620, otherwise, if (i) is determined to not be greater than (ii), then process 600 may proceed from operation 614 to operation 618 where potential request time t may not be added to an initial customized authentication request schedule before proceeding to operation 620. This may enable process 600 to add a particular selected potential request time t to an initial customized authentication request schedule only when the expected gain of E(t+1) for trying at a consecutively later potential request time t+1 is less than the combined expected gain of P(t)*A−F+E(t+1)*(1−P(t)) for trying at the particular selected potential request time t and for trying at the consecutively later potential request time t+1 if the attempt at time t was unsuccessful (e.g., try at selected time t only if the expected gain when trying at time t+1 is less than the combined expected gain of trying at time/and trying at time t+1 only if the attempt at time t was unsuccessful).

As just one example of such a comparison, where a currently selected potential request time t that is request time 120 out of 240 potential request times is determined to have an ARAP [P(t120)] of 0.4 (e.g., at operation 608), where the consecutively next potential request time 121 out of 240 potential request times is determined to have an expected gain E(t+1) of $5.00 (e.g., at a previous iteration of operation 610), where an expected gain [E(t120)] may be defined by process 600 to be calculated as E(t)=P(t)*A−F+(1−P(t))*E(t+1), where A is defined to be $10.00, and where F is defined to be $1.00, such that E(t120) may be determined to be $6.00 (e.g., at a current iteration of operation 610) and such that E(t121) may be determined to be $5.00 (e.g., at a current iteration of operation 612 and/or previous iteration of operation 610), then process 600 may be operative to determine (e.g., at operation 614) that (ii) E(t121) of $5.00 is less than (i) E(t120) of $6.00 [0.4*$10.00−$1.00+(1−0.4)*$5.00] (i.e., that an expected gain of $5.00 for only trying at t121 is less than an expected gain of $6.00 for trying at t120 and then at t121 only when the attempt at 1120 is unsuccessful), such that process 600 may advance from operation 614 to operation 620 via operation 616 rather than via operation 618, such that selected potential request time t120 is added to the initial customized authorization request schedule. As just one other example, when process 600 may advance to operation 620 after determining that E(t121) is less than E(t120) when particular potential request time t120 was selected, as described above, operation 620 may determine that not every potential request time t has been selected and may advance to operation 619 where a next (e.g., consecutively earlier) potential request time t119 may be selected before returning to another iteration of operations 610, 612, and 614 during which t is t119 and t+1 is t120. In such another iteration of operations 610, 612, and 614, where a selected potential request time t that is request time 119 out of 240 potential request times is determined to have an ARAP [P(t119)] of 0.1 (e.g., at operation 608), where the consecutively next potential request time 120 out of 240 potential request times is determined to have an expected gain E(t+1) of $6.00 (e.g., at a previous iteration of operation 610, as described above), where an expected gain [E(t119)] may be defined by process 600 to be calculated as E(t)=P(t)*A−F+(1−P(t))*E(t+1), where A is defined to be $10.00, and where F is defined to be $1.00, such that E(t119) may be determined to be $5.40 (e.g., at a current iteration of operation 610) and such that E(t120) may be determined to be $6.00 (e.g., at a current iteration of operation 612 and/or previous iteration of operation 610), then process 600 may be operative to determine (e.g., at operation 614) that (ii) E(t120) of $6.00 is greater than (i) E(t119) of $5.40 [0.1*$10.00−$1.00+(1−0.1)*$6.00] (i.e., that an expected gain of $6.00 for only trying at t120 is greater than an expected gain of $5.40 for trying at t119 and then at t120 only when the attempt at t119 is unsuccessful), such that process 600 may advance from operation 614 to operation 620 via operation 618 rather than via operation 616, such that selected potential request time t120 is not added to the initial customized authorization request schedule.

The first overall iteration of operation 610 may be operative to select the final potential request time tT (e.g., time t240) and then each iteration of operation 619 may be operative to select the potential request time that is consecutively prior to the previously selected potential request time (e.g., time t239, then time t 238, . . . , then time t 2, and then time t1), for example, such that process 600 may work backwards through the set of all potential request times t1−tT as may be identified at operation 606. However, in such embodiments, process 600 may be operative to uniquely handle operation 612 during the first iteration of operations 610-620, as it may not be possible to routinely determine E(t+1) when the currently selected potential request time t is the final potential request time tT, whereby process 600 may be operative at such an initial iteration of operation 612 to calculate such an E(tT+1) to be equal to a churn cost −C, where churn cost −C may be the amount to be lost by the SP subsystem if it were unable to successfully receive authorization to fund the particular customer transaction (e.g., if the authorization request made by the SP subsystem at each request time of the customized authorization request schedule were to be unsuccessful, such that the customer may churn). As just one example, where A may be $10.00 and F may be $1.00 and C may be $60.00 (e.g., as may be defined in any suitable manner (e.g., by the SP subsystem)), if P(tT) was predicted to be 0.9 by the ARAP model, then the expected gain E(tT+1) may be determined by the statistical model (e.g., at operation 612) to be −$60.00 and E(tT) may be determined (e.g., at operation 610) to be $2.00, then process 600 may be operative to determine (e.g., at operation 614) that (ii) E(tT+1) of −$60.00 is less than (i) E(IT) of $2.00 [0.9*$10.00−$1.00+(1−0.9)*−$60.00](i.e., that an expected gain of −$60.00 for only trying at tT+1 is less than an expected gain of $2.00 for trying at tT and then at tT+1 only when the attempt at IT is unsuccessful), such that process 600 may advance from operation 614 to operation 620 via operation 616 rather than via operation 618, such that selected potential request time tT is added to the initial customized authorization request schedule.

It is to be understood that the manner in which an expected gain for a particular time t may be determined based on an ARAP P(t) (e.g., P(t)*A−F+(1−P(t))*E(t+1)) may be any suitable calculation or determination using any suitable equation or function of P(t) and/or using any suitable variable cost elements, such as A, F, C, and/or the like of any suitable values, which may be changed over time as the SP subsystem may see fit to best determine an expected gain based on changing operation costs and/or transaction costs and/or chum costs and/or the like, using any suitable statistical model(s) at operations 610 and/or 612 that may be completely independent from how an ARAP model may be configured and/or trained and/or utilized for determining an ARAP value for a particular time t, such that a flexible and tunable hybrid model solution may be realized. Additionally or alternatively, it is to be understood that the manner in which a calculated expected gain E(t) for a particular selected potential request time t may be compared (e.g., at operation 614) to any suitable comparator, such as to an expected gain for a consecutive other potential request time (e.g., E(t−1) and/or E(t+1)) and/or to any suitable threshold, in order to determine selectively whether or not that particular selected potential request time t ought to be added to an initial customized authorization request schedule, may be any suitable calculation or determination using any suitable equation or function or comparison (e.g., (A) add t to schedule if E(t−1)<E(t)>E(t+1) (e.g., try at selected time t when E(t) is a peak of some sort), (B) add t to schedule if E(t)>E(I+1) (e.g., try at selected time t if the expected gain when trying at time t+1 is less than the expected gain of trying at time t, where E(Q) may be calculated as P(I)*A−F+(1−P(t))*E(t+1), such that the current expected gain E(I) may be dependent on the future expected gain E(t+1), which may be why an expected gain calculation may be made from the last time T and then calculated in reverse order by time), (C) add t to schedule if E(t)>any suitable threshold (e.g., a fixed threshold or any suitable threshold calculated in any suitable manner based on all the calculated E(t)'s of all potential request times), and/or the like).

Once an initial authorization request schedule has been defined based on each one of the T iterations of operations 610, 612, 614, 616 or 618, 619, and 620 (e.g., based on considering the expected gain of each one of the potential request times), process 600 may advance from operation 620 to operation 625, where any suitable constraints or filters may be applied to the initial authorization request schedule. For example, one or more constraints or filters may be applied at operation 625 for reducing the number of request times of the authorization request schedule by eliminating some of the request times that may define the initial authorization request schedule. For example, operation 625 may be operative to limit the number of request times in an authorization request schedule to no more than N request times, where the value of N may be determined in any suitable manner, such as by an equation where N<((A*R)/F), where A may be the amount to be paid to the SP subsystem if any authorization request of the schedule were successful (e.g., the purchase price for the transaction), where F may be the overhead cost (e.g., transaction cost and/or operation cost) incurred by the SP subsystem for making an authorization request, and where R may be a fee ratio desired by the SP subsystem. As just one example, if the initial authorization request schedule defined prior to operation 625 (e.g., during a schedule computation subprocess 691 of process 600) includes 8 request times of the 240 potential request times identified at operation 606, and if A may be $10.00 and F may be $1.00 and R may be 0.5, then N may be calculated to be less than 5 (e.g., less than $10.00*0.5/$1.00 (e.g., 4)), such that only 4 of the 8 request times of the initial authorization request schedule may be maintained (e.g., after operation 625). Operation 625 may be operative to remove the appropriate number of request times in any suitable manner, such as by removing the request times associated with the lowest expected gains. It is to be understood that the manner in which any suitable number of request times may be removed in any suitable manner from an initial customized authorization request schedule may be determined using any suitable calculation(s) or determination(s) using any suitable variable cost elements, such as A, F, C, R, and/or the like of any suitable values, which may be changed over time as the SP subsystem may see fit to best determine an any suitable constraints or filters (e.g., business constraints) based on changing operation costs and/or transaction costs and/or churn costs and/or SP goals and/or the like, using any suitable strategic (e.g., business) model(s) at operation 625 that may be completely independent from how an ARAP model may be configured and/or trained and/or utilized for determining an ARAP value for a particular time t, and/or that may be completely independent from how any potential request times are selectively added to an initial customized authorization request schedule, such that a flexible and tunable hybrid model solution may be realized.

Once a customized authorization request schedule has been initially defined (e.g., at subprocess 691) and optionally filtered (e.g., at operation 625), a customized authorization request schedule for a particular customer's transaction may be executed at a schedule execution subprocess 699. For example, operation 620 may proceed (e.g., via operation 625) to an operation 630, at which process 600 may determine whether the current time matches a scheduled time of the customized authorization request schedule. If not, operation 630 may be repeated until a match is determined. Once a match is determined, process 600 may proceed from operation 630 to an operation 632, at which an authorization request for the particular customer's transaction may be requested (e.g., an authorization request may be communicated between SP subsystem 200 and an appropriate CM subsystem 300). If that authorization request of operation 632 is determined to have been successful at operation 634, then process 600 may proceed to operation 636, at which the scheduled payment of the particular customer's transaction may be deemed complete and the remainder (if any) of the customized authorization request schedule may be ignored. Alternatively, if that authorization request of operation 632 is determined to have been unsuccessful at operation 634, then process 600 may return to operation 630, at which process 600 may again determine whether the current time matches a scheduled time of the customized authorization request schedule (e.g., the next scheduled time of the customized authorization request schedule).

It is understood that the operations shown in process 600 of FIG. 6 are only illustrative and that existing operations may be modified or omitted, additional operations may be added, and the order of certain operations may be altered. Therefore, SP subsystem 200 may be configured to provide a new layer of efficiency and/or effectiveness and/or control to defining an authorization request schedule by customizing one or more aspects of an authorization request schedule (e.g., the number and/or the timing of authorization requests of an authorization request schedule) afforded by the SP subsystem to a particular customer's transaction for minimizing the number of authorization requests and/or for maximizing the number of successful authorization requests and/or otherwise improving or optimizing or maximizing the success rate of each authorization request of the schedule (e.g., for reducing costs associated with carrying out an authorization request schedule). Using particular test/training transactional data from previous transaction authorization requests with known outcomes, an authorization request approval probability model may be generated/trained for appropriately predicting/determining the probability of success of an authorization request for a particular transaction at a particular potential request time. By creating one or more models that have been generated using trusted test data, such model(s) may be relied on by the system to accurately predict one or more potential request times that may have effective expected gains, which may enable server 210 to efficiently and effectively balance risk and reward for customizing an appropriate authorization request schedule for a particular customer transaction situation with an SP. In some embodiments, a model may be updated and/or any suitable model input features may be updated for re-customizing a schedule during the schedule itself (e.g., by returning from operation 634 to operation 606 rather than operation 630), such that a schedule may be further customized and dynamically adjusted to further mitigate risk by intelligently and efficiently updating the schedule accordingly (e.g., by utilizing new data about customer authorization success (e.g., an unsuccessful attempt at an iteration of operation 634), etc.).

### Further Description of FIGS. 1-6

One, some, or all of the processes described with respect to FIGS. 1-6 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 104 of FIG. 2). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device or subsystem to another electronic device or subsystem using any suitable communications protocol (e.g., the computer-readable medium may be communicated to electronic device 100 via communications circuitry 114 (e.g., as at least a portion of an application 103 and/or as at least a portion of an application 103a)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is understood that any, each, or at least one module or component or subsystem of system 1 may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

At least a portion of one or more of the modules or components or subsystems of system 1 may be stored in or otherwise accessible to an entity of system 1 in any suitable manner (e.g., in memory 104 of device 100 (e.g., as at least a portion of an application 103 and/or as at least a portion of an application 103a)). Any or all of the modules or other components of system 1 may be mounted on an expansion card, mounted directly on a system motherboard, or integrated into a system chipset component (e.g., into a “north bridge” chip).

Any or each module or component of system 1 may be a dedicated system implemented using one or more expansion cards adapted for various bus standards. For example, all of the modules may be mounted on different interconnected expansion cards or all of the modules may be mounted on one expansion card. Any or each module or component of system 1 may include its own processing circuitry and/or memory. Alternatively, any or each module or component of system 1 may share processing circuitry and/or memory with any other module.

As described above, one aspect of the present technology is the gathering and use of data available from various sources to customize authorization request schedules. The present disclosure contemplates that in some instances, this gathered data may include personal information data that uniquely identifies or can be used to contact or locate a specific person. Such personal information data can include demographic data, location-based data, telephone numbers, email addresses, social network identifiers, home addresses, office addresses, data or records relating to a user's health or level of fitness (e.g., vital signs measurements, medication information, exercise information, etc.) or purchase history, date of birth, or any other identifying or personal information.

The present disclosure recognizes that the use of such personal information data, in the present technology, can be used to the benefit of users. The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (“HIPAA”); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location detection services, the present technology can be configured to allow users to select to “opt in” or “opt out” of participation in the collection of personal information data during registration for services or anytime thereafter. In addition to providing “opt in” or “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, customizing authorization request schedules can be made based on non-personal information data or a bare minimum amount of personal information, such as the content being requested by the device associated with a user, other non-personal information available to the device, or publicly available information.

While there have been described systems, methods, and computer-readable media for customizing authorization request schedules, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for customizing, using a management server, an authorization request schedule afforded to a customer in a transaction for a product between a service provider and the customer using a payment credential, the method comprising:
detecting, with the management server, a transaction due date for a payment in the transaction using the payment credential;
identifying, with the management server, a plurality of potential request times associated with the detected transaction due date;
for each potential request time of the identified plurality of potential request times, running, with the management server, a trained authorization request approval probability (“ARAP”) model on transaction feature data associated with the transaction to predict a probability of an authorization request approval of the payment for that potential request time;
selecting, with the management server, a particular potential request time of the identified plurality of potential request times;
calculating, with the management server, an expected gain for the selected particular potential request time using the predicted probability of an authorization request approval of the payment for the selected particular potential request time;
comparing, with the management server, the calculated expected gain for the selected particular potential request time to a comparator; and
determining, with the management server, whether or not to add the selected particular potential request time to the authorization request schedule based on the comparing.

2. The method of claim 1, wherein every two consecutive potential request times of the plurality of potential request times are separated by a time interval.

3. The method of claim 2, wherein the time interval is at least one hour.

4. The method of claim 1, wherein the comparator comprises a threshold value.

5. The method of claim 1, wherein the comparator comprises an expected gain for another potential request time of the identified plurality of potential request times that is consecutive in the identified plurality of potential request times with the selected particular potential request time.

6. The method of claim 5, wherein the other potential request time is consecutively after the selected particular potential request time in the identified plurality of potential request times.

7. The method of claim 6, wherein the determining comprises:
adding the selected particular potential request time to the authorization request schedule when the calculated expected gain for the selected particular potential request time is greater than the expected gain for the other potential request time; and
not adding the selected particular potential request time to the authorization request schedule when the calculated expected gain for the selected particular potential request time is less than the expected gain for the other potential request time.

8. The method of claim 7, wherein the calculating comprises calculating the expected gain for the selected particular potential request time using:
the predicted probability of an authorization request approval of the payment for the selected particular potential request time; and
an expected gain for the other potential request time.

9. The method of claim 7, wherein the calculating comprises calculating the expected gain for the selected particular potential request time using:
the predicted probability of an authorization request approval of the payment for the selected particular potential request time;
a churn cost if the payment is not made;
a currency amount of the payment; and
an overhead cost for making an authorization request for the payment.

10. The method of claim 7, wherein the calculating comprises calculating the expected gain for the selected particular potential request time using:
the predicted probability of an authorization request approval of the payment for the selected particular potential request time;
an expected gain for the other potential request time;
a currency amount of the payment; and
an overhead cost for making an authorization request for the payment.

11. The method of claim 6, wherein the comparator further comprises an expected gain for yet another potential request time of the identified plurality of potential request times that is consecutive in the identified plurality of potential request times with the selected particular potential request time.

12. The method of claim 11, wherein the yet another potential request time is consecutively prior to the selected particular potential request time in the identified plurality of potential request times.

13. The method of claim 12, wherein the determining comprises:
adding the selected particular potential request time to the authorization request schedule when the calculated expected gain for the selected particular potential request time is greater than each one of the expected gain for the other potential request time and the expected gain for the yet another potential request time; and
not adding the selected particular potential request time to the authorization request schedule when the calculated expected gain for the selected particular potential request time is less than at least one of the expected gain for the other potential request time or the expected gain for the yet another potential request time.

14. The method of claim 1, wherein the transaction feature data of the running comprises at least one of the following:
the hour of the day of the potential request time;
the day of the week of the potential request time;
the day of the month of the potential request time;
the month of the year of the potential request time;
the hour of the day of the detected transaction due date;
the day of the week of the detected transaction due date;
the day of the month of the detected transaction due date;
the month of the year of the detected transaction due date; and
duration of time between the potential request time and the detected transaction due date.

15. The method of claim 1, wherein the transaction feature data of the running comprises at least one of the following:
a date on which the payment credential was introduced to the management server;
a type of the payment credential;
a type of credential manager subsystem that manages the payment credential;
a date on which the payment credential expires;
the number of times the customer has updated billing information associated with the transaction;
duration of time since the last time the customer updated billing information associated with the transaction; and
a currency amount of the payment.

16. The method of claim 1, wherein the transaction feature data of the running comprises at least one of the following:
a date on which the customer was introduced to the management server;
a location of the customer; and
a type of the product credential.

17. The method of claim 1, wherein:
the determining comprises adding the selected particular potential request time to the authorization request schedule based on the comparing; and
after the adding, at the selected particular potential request time, requesting an authorization of the payment in the transaction using the payment credential.

18. The method of claim 17, wherein, when the requested authorization is not successful, the method further comprises:
re-training the ARAP model on additional transaction feature data that is newer than the transaction feature data;
for at least one other particular potential request time of the identified plurality of potential request times that follows the selected particular potential request time, running, with the management server, the re-trained ARAP model on at least some of the transaction feature data associated with the transaction to predict a probability of an authorization request approval of the payment for that at least one other particular potential request time;
choosing, with the management server, one of the at least one other particular potential request times;
calculating, with the management server, an expected gain for the chosen one of the at least one other particular potential request times using the predicted probability of an authorization request approval of the payment for the chosen one of the at least one other particular potential request times;
comparing, with the management server, the calculated expected gain for the chosen one of the at least one other particular potential request times to the comparator; and
determining, with the management server, whether or not to add the chosen one of the at least one other particular potential request times to the authorization request schedule based on the comparing.

19. A system for customizing an authorization request schedule, comprising:
a credential manager subsystem that manages a payment credential of a customer; and
a service provider subsystem that offers a product to the customer, wherein the service provider subsystem is configured to:
detect a due date for a payment using the payment credential in a transaction for the product between the service provider subsystem and the customer;
in response to the detection of the due date, identify a plurality of potential request times associated with the due date;
for each potential request time of the identified plurality of potential request times:
predict, using a trained probability model, a probability of an authorization request approval of the payment if made at that potential request time;
calculate an expected gain for the that potential request time using the predicted probability of an authorization request approval of the payment if made at that potential request time; and
selectively update the authorization request schedule with that potential request time based on the calculated expected gain for that potential request time; and
at a first potential request time of the updated authorization request schedule, request, of the credential manager subsystem, an authorization of the payment using the payment credential.

20. A non-transitory machine readable medium storing a program for execution by at least one processing unit of a management server, the program for customizing an authorization request schedule, the program comprising sets of instructions for:
predicting, using a trained probability model, a probability of an authorization request approval of a payment if made at a potential request time;
calculating, using a statistical model, an expected gain for the potential request time based on the predicted probability;
adding the potential request time to the authorization request schedule based on the calculated expected gain; and
after the adding, at the potential request time of the authorization request schedule, attempting to obtain approval of an authorization request of the payment.
